(19) United States
(12) Patent Application Publication
(10) Pub. No.: US 2003/0016415 A1
(43) Pub. Date: Jan. 23, 2003

(54) Distribution system using multiple lasers of differing frequencies combined on a single optical output device and method of fabricating such optical output device

(75) Inventors: Wang Jun, Horsham, PA (US); Timothy J. Brophy, Holland, PA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MOTOROLA, INC., Schaumburg, IL (US)

(21) Appl. No.: 09/910,032

(22) Filed: Jul. 23, 2001

(51) Int. Cl. H04J 14/02

(52) U.S. Cl. 359/133; 359/124

(57) ABSTRACT

An optical output device (164) includes a moncrystalline silicon substrate (102) and multiple light sources (168a-168n) formed of compound semiconductor materials. An accommodating buffer layer (104) lies between the light sources (168a-168n) and the substrate (102). An optical interconnect (170), such as a waveguide, is formed over the multiple light sources (168a-168n) and connects them to an output port (172). The accommodating buffer layer (104) is a layer of monocrystalline oxide spaced apart from the silicon substrate (102) by an amorphous interface layer (106) of silicon oxide, and is lattice matched to both the underlying silicon substrate (102) and the waveguide (170). Any lattice mismatch between the accommodating buffer layer (104) and the underlying silicon substrate (102) is taken care of by the amorphous interface layer (106).

### BACKGROUND OF THE INVENTION

1. Field of the Invention

The present invention relates generally to semiconductor structures and devices and to a method for their fabrication, and more specifically to semiconductor light sources and multiplexers used for optical communications.

2. Description of the Related Art

Optical transmission systems are used in various communications systems, such as telephone systems, cable television (CATV) systems and computer networks. A single fiber can support very large bandwidths and has low attenuation, which makes it a desirable medium for transmitting information. As such, the demand for optical communication networks and for increasing the bandwidth of such networks has been increasing rapidly.

To transmit an information signal like a television signal over an optical fiber, a light beam or carrier must be modulated with the information signal. For example, in CATV systems, a coherent light wave is modulated by a radio frequency (RF) signal that contains audio, video and other information. The modulated carrier is then transmitted to a receiver via the optical fiber. Amplifiers are provided along the fiber to maintain an acceptable carrier to noise ratio (CNR).

Components are evolving to support new multi-channel, faster bit rate networks. In addition to faster bit rates, smaller and more cost effective optical components are desired. One way to achieve this is by integrating multiple components onto a single chip package, which reduces both cost and size. Placing more components on a single substrate eliminates interconnects and non-linear effects coming out of the devices, and can also reduce insertion loss. Unfortunately, integration of optical components has occurred on only a single layer of a substrate. Integration has been inhibited due to lattice mismatches between the substrate and the device materials grown on the substrate.

Semiconductor devices often include multiple layers of conductive, insulating, and semiconductive layers. Often, the desirable properties of such layers improve with the crystallinity of the layer. For example, the electron mobility and band gap of semiconductive layers improves as the crystallinity of the layer increases. Similarly, the free electron concentration of conductive layers and the electron charge displacement and electron energy recoverability of insulative or dielectric films improves as the crystallinity of these layers increases.

For many years, attempts have been made to grow various monolithic thin films on a foreign substrate such as silicon. To achieve optimal characteristics of the various monolithic layers, however, a monocrystalline film of high crystalline quality is needed. Attempts have been made, for example, to grow various monocrystalline layers on a substrate such as germanium, silicon, and various insulators. These attempts have generally been unsuccessful because lattice mismatches between the host crystal and the grown crystal have caused the resulting layer of monocrystalline material to be of low crystalline quality.

If a large area thin film of high quality monocrystalline material was available at low cost, a variety of semiconductor devices could advantageously be fabricated in or using that film at a low cost compared to the cost of fabricating such devices beginning with a bulk wafer of semiconductor material or in an epitaxial film of such material on a bulk wafer of semiconductor material. In addition, if a thin film of high quality monocrystalline material could be realized beginning with a bulk wafer such as a silicon wafer, an integrated device structure could be achieved that takes advantage of the best properties of both the silicon and the high quality monocrystalline material.

Accordingly, a need exists for a semiconductor structure that provides a high quality monocrystalline film or layer over another monocrystalline material and for a process for making such a structure so that true two-dimensional growth can be achieved for the formation of quality semiconductor structures, devices and integrated circuits having grown monocrystalline film with the same crystal orientation as an underlying substrate.

### SUMMARY OF THE INVENTION

In one embodiment, the present invention is a signal distribution system using multiple light sources of differing frequencies that are combined on a single optical output device. The distribution system includes a plurality of modulators, each modulator receiving a first signal and a second signal, and combining the first and second signals to generate one of a corresponding plurality of modulating signals. The optical output device is connected to the modulators and receives the modulating signals. The optical output device includes a plurality of light sources operating at different wavelengths. Each of the light sources receives one of the modulating signals such that each of the wavelengths is modulated with one of the modulating signals and generates an optical signal. An optical interconnect is optically connected to the light sources and connects the light sources to an output port of the optical output device. The light sources and the optical interconnect are formed on a single monocrystalline substrate.

### BRIEF DESCRIPTION OF THE DRAWINGS

The foregoing summary, as well as the following detailed description of preferred embodiments of the invention, will be better understood when read in conjunction with the appended drawings. The present invention is illustrated by way of example and not limitation in the accompanying figures. Thus, it should be understood that the invention is not limited to the precise arrangements and instrumentalities shown. In the drawings, in which like references indicate similar elements:

FIGS. 1, 2, and 3 illustrate schematically, in cross-section, device structures in accordance with various embodiments of the invention;

FIG. 4 illustrates graphically the relationship between maximum attainable film thickness and lattice mismatch between a host crystal and a grown crystalline overlayer;

FIG. 5 illustrates a high resolution Transmission Electron Micrograph of a structure including a monocrystalline accommodating buffer layer;

FIG. 6 illustrates an x-ray diffraction spectrum of a structure including a monocrystalline accommodating buffer layer;

FIG. 7 illustrates a high resolution Transmission Electron Micrograph of a structure including an amorphous oxide layer;

FIG. 8 illustrates an x-ray diffraction spectrum of a structure including an amorphous oxide layer;

FIGS. 9-12 illustrate schematically, in cross-section, the formation of a device structure in accordance with another embodiment of the invention;

FIGS. 13-16 illustrate a probable molecular bonding structure of the device structures illustrated in FIGS. 9-12;

FIGS. 17-20 illustrate schematically, in cross-section, the formation of a device structure in accordance with still another embodiment of the invention;

FIGS. 21-23 illustrate schematically, in cross-section, the formation of yet another embodiment of a device structure in accordance with the invention;

FIGS. 24-30 are cross-sectional views of a portion of an integrated circuit that includes a semiconductor laser and a MOS transistor in accordance with the present invention;

FIG. 31 is a schematic block diagram of a signal distribution system in accordance with one embodiment of the invention;

FIG. 32 is a schematic block diagram of a signal distribution system in accordance with another embodiment of the invention;

FIG. 33 is a top view of a system in accordance with another exemplary embodiment of the present invention;

FIG. 34 is a cross-sectional view of a groove formed in a substrate of the system of FIG. 33; and

FIG. 35 is a cross-sectional view of another embodiment of the invention in which both a light source and a fiber optic cable are located within a trench formed within a substrate.

Those of ordinary skill in the art will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

As used herein, the terms “comprises,” “comprising,” or any other variation thereof, are intended to cover a non-exclusive inclusion, such that a process, method, article, or apparatus that comprises a list of elements is not required to include only those elements, but may include other elements not expressly listed or inherent to such process, method, article, or apparatus.

Referring now to the drawings, FIG. 1 is a schematic, cross-sectional view of a portion of a semiconductor structure 20 in accordance with an embodiment of the invention. The semiconductor structure 20 includes a monocrystalline substrate 22, an accommodating buffer layer 24 comprising a monocrystalline material, and a monocrystalline material layer 26. In this context, the term “monocrystalline” shall have the meaning commonly used within the semiconductor industry. The term refers to materials that are a single crystal or that are substantially a single crystal and includes those materials having a relatively small number of defects such as dislocations and the like as are commonly found in substrates of silicon or germanium or mixtures of silicon and germanium and epitaxial layers of such materials commonly found in the semiconductor industry.

In accordance with one embodiment of the invention, the structure 20 also includes an amorphous intermediate layer 28 positioned between the substrate 22 and the accommodating buffer layer 24. The structure 20 may also include a template layer 30 between the accommodating buffer layer 24 and the monocrystalline material layer 26. As will be explained more fully below, the template layer 30 helps to initiate the growth of the monocrystalline material layer 26 on the accommodating buffer layer 24. The amorphous intermediate layer 28 helps to relieve the strain in the accommodating buffer layer 24 and by doing so, aids in the growth of a high crystalline quality accommodating buffer layer.

The substrate 22, in accordance with an embodiment of the invention, is a monocrystalline semiconductor or compound semiconductor wafer, preferably of large diameter. The wafer can be of, for example, a material from Group IV of the periodic table. Examples of Group IV semiconductor materials include silicon, germanium, mixed silicon and germanium, mixed silicon and carbon, mixed silicon, germanium and carbon, and the like. Preferably the substrate 22 is a wafer containing silicon or germanium, and most preferably is a high quality monocrystalline silicon wafer as used in the semiconductor industry.

The accommodating buffer layer 24 is preferably a monocrystalline oxide or nitride material epitaxially grown on the underlying substrate 22. In accordance with one embodiment of the invention, the amorphous intermediate layer 28 is grown on the substrate 22 at the interface between the substrate 22 and the growing accommodating buffer layer 24 by the oxidation of the substrate 22 during the growth of the accommodating buffer layer 24. The amorphous intermediate layer 28 serves to relieve strain that might otherwise occur in the monocrystalline accommodating buffer layer 24 as a result of differences in the lattice constants of the substrate 22 and the accommodating buffer layer 24. As used herein, lattice constant refers to the distance between atoms of a cell measured in the plane of the surface. If such strain is not relieved by the amorphous intermediate layer 28, the strain may cause defects in the crystalline structure of the accommodating buffer layer 24. Defects in the crystalline structure of the accommodating buffer layer 24, in turn, would make it difficult to achieve a high quality crystalline structure in the monocrystalline material layer 26 which may comprise a semiconductor material, a compound semiconductor material, or another type of material such as a metal or a non-metal.

The accommodating buffer layer 24 is preferably a monocrystalline oxide or nitride material selected for its crystalline compatibility with the underlying substrate 22 and with the overlying material layer 26. For example, the material of the accommodating buffer layer 24 could be an oxide or nitride having a lattice structure closely matched to the substrate 22 and to the subsequently applied monocrystalline material layer 26. Materials that are suitable for the accommodating buffer layer 24 include metal oxides such as the alkaline earth metal titanates, alkaline earth metal zirconates, alkaline earth metal hafnates, alkaline earth metal tantalates, alkaline earth metal ruthenates, alkaline earth metal niobates, alkaline earth metal vanadates, alkaline earth metal tin-based perovskites, lanthanum aluminate, lanthanum scandium oxide, and gadolinium oxide. Additionally, various nitrides such as gallium nitride, aluminum nitride, and boron nitride may also be used for the accommodating buffer layer 24. Most of these materials are insulators, although strontium ruthenate, for example, is a conductor. Generally, these materials are metal oxides or metal nitrides, and more particularly, these metal oxide or nitrides typically include at least two different metallic elements. In some specific applications, the metal oxides or nitrides may include three or more different metallic elements.

The material for the monocrystalline material layer 26 can be selected, as desired, for a particular structure or application. For example, the monocrystalline material of the monocrystalline material layer 26 may comprise a compound semiconductor that can be selected, as needed for a particular semiconductor structure, from any of the Group IIIA and VA elements (III-V semiconductor compounds), mixed III-V compounds, Group II (A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like. However, the monocrystalline material layer 26 may also comprise other semiconductor materials, metals, or non-metal materials that are used in the formation of semiconductor structures, devices and/or integrated circuits.

The amorphous intermediate layer 28 is preferably an oxide formed by the oxidation of the surface of the substrate 22, and more preferably is composed of a silicon oxide. The thickness of the intermediate layer 28 is sufficient to relieve strain attributed to mismatches between the lattice constants of the substrate 22 and the accommodating buffer layer 24. Typically, the intermediate layer 28 has a thickness in the range of approximately 0.5-5 nm.

Appropriate materials for template 30 are discussed below. Suitable template materials chemically bond to the surface of the accommodating buffer layer 24 at selected sites and provide sites for the nucleation of the epitaxial growth of the monocrystalline material layer 26. When used, the template layer 30 has a thickness ranging from about 1 to about 10 monolayers.

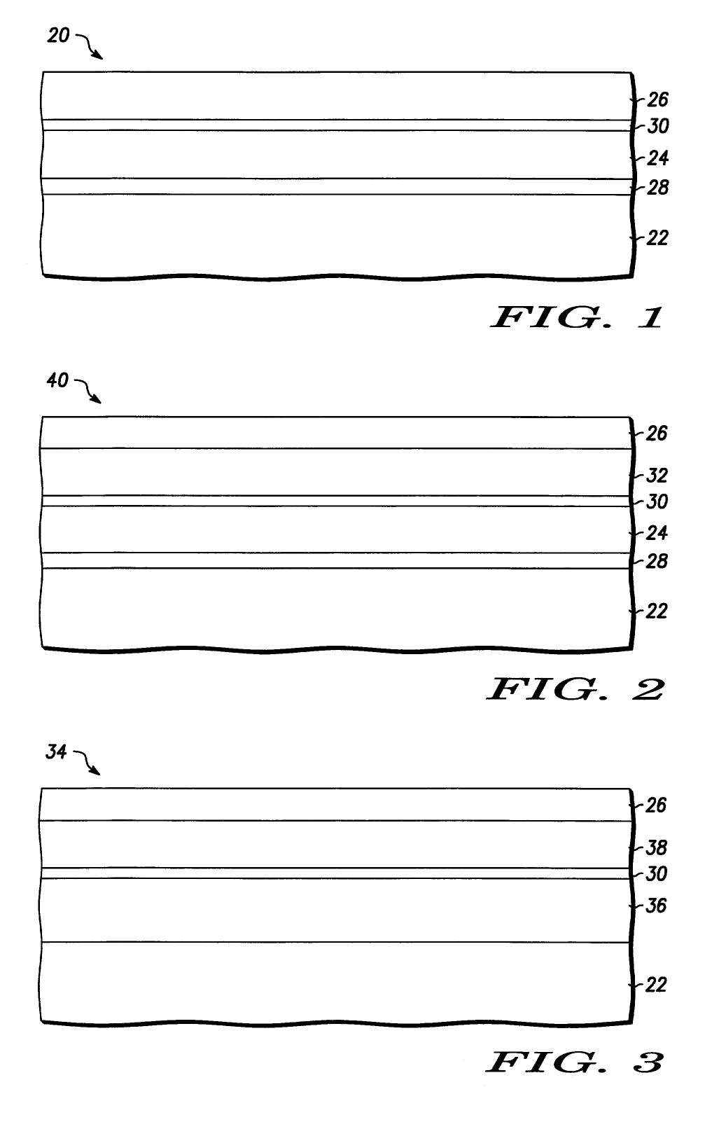

FIG. 2 illustrates, in cross-section, a portion of a semiconductor structure 40 in accordance with a further embodiment of the invention. The structure 40 is similar to the previously described semiconductor structure 20, except that an additional buffer layer 32 is positioned between the accommodating buffer layer 24 and the monocrystalline material layer 26. Specifically, the additional buffer layer 32 is positioned between the template layer 30 and the overlying monocrystalline material layer 26. The additional buffer layer 32, formed of a semiconductor or compound semiconductor material when the monocrystalline material layer 26 comprises a semiconductor or compound semiconductor material, serves to provide a lattice compensation when the lattice constant of the accommodating buffer layer 24 cannot be adequately matched to the overlying monocrystalline semiconductor or compound semiconductor material layer 26.

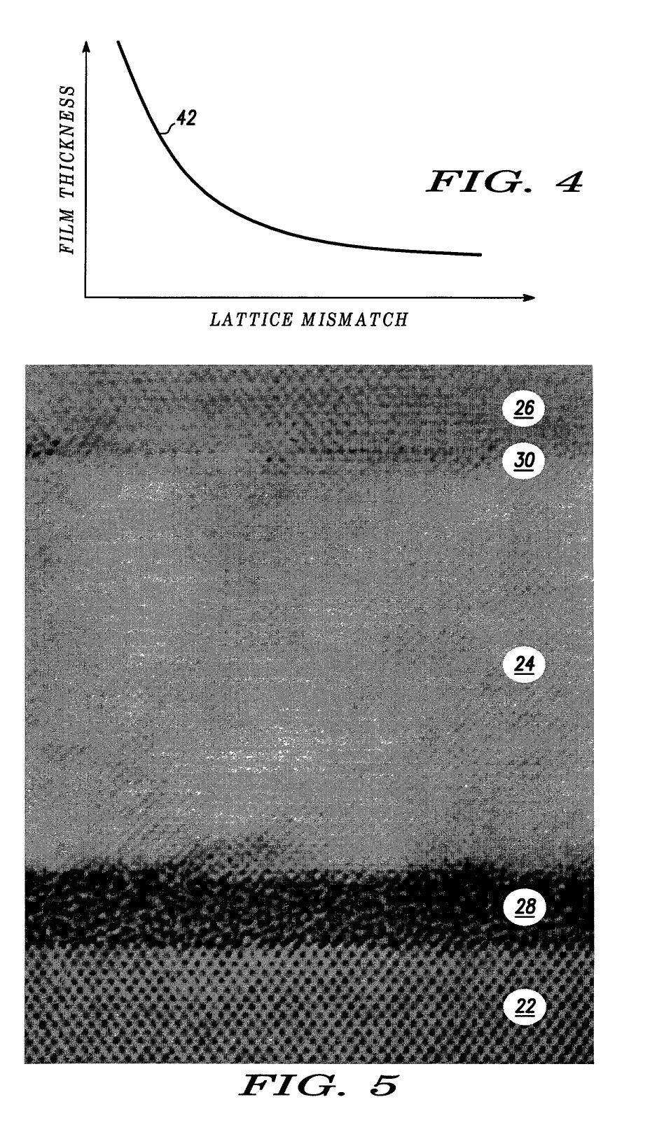

FIG. 3 schematically illustrates, in cross-section, a portion of a semiconductor structure 34 in accordance with another exemplary embodiment of the invention. The structure 34 is similar to the structure 20, except that the structure 34 includes an amorphous layer 36, rather than the accommodating buffer layer 24 and the amorphous interface layer 28, and an additional monocrystalline layer 38.

As explained in greater detail below, the amorphous layer 36 may be formed by first forming an accommodating buffer layer and an amorphous interface layer in a similar manner to that described above. The additional monocrystalline layer 38 is then formed, by epitaxial growth, overlying the accommodating buffer layer. The accommodating buffer layer is then exposed to an anneal process to convert it to an amorphous layer. The amorphous layer 36 formed in this manner comprises materials from both the accommodating buffer layer and the amorphous intermediate layer, which amorphous layers may or may not amalgamate. Thus, the amorphous layer 36 may comprise one or two amorphous layers. Formation of the amorphous layer 36 between the substrate 22 and the monocrystalline layer 26 (subsequent to additional layer 38 formation) relieves stresses between the substrate 22 and the additional monocyrstalline layer 38 and provides a true compliant substrate for subsequent processing, e.g., monocrystalline material layer 26 formation.

The processes described above in connection with FIGS. 1 and 2 are adequate for growing monocrystalline material layers over a monocrystalline substrate. However, the process described in connection with FIG. 3, which includes transforming a monocrystalline accommodating buffer layer to an amorphous oxide layer, may be better for growing monocrystalline material layers because it allows any strain in the monocrystalline material layer 26 to relax.

The additional monocrystalline layer 38 may include any of the materials described throughout this application in connection with either of the monocrystalline material layer 26 or the additional buffer layer 32. For example, when the monocrystalline material layer 26 comprises a semiconductor or compound semiconductor material, the additional layer 38 may include monocrystalline Group IV or monocrystalline compound semiconductor materials.

In accordance with one embodiment of the present invention, the additional monocrystalline layer 38 serves as an anneal cap during formation of the amorphous layer 36 and as a template for the subsequent formation of the monocrystalline material layer 26. Accordingly, the additional monocrystalline layer 38 is preferably thick enough to provide a suitable template for growth of the monocrystalline material layer 26 (at least one monolayer) and thin enough to allow the additional monocrystalline layer 38 to form as a substantially defect free monocrystalline material.

In accordance with another embodiment of the invention, the additional monocrystalline layer 38 comprises monocrystalline material, such as a material discussed above in connection with the monocrystalline layer 26 that is thick enough to form devices within the additional layer 38. In this case, a semiconductor structure in accordance with the present invention does not include the monocrystalline material layer 26. That is, the semiconductor structure in accordance with this embodiment only includes one monocrystalline layer located above the amorphous layer 36.

The following non-limiting, illustrative examples illustrate various combinations of materials useful in structures 20, 40, and 34 in accordance with various alternative embodiments of the invention. These examples are merely illustrative, and it is not intended that the invention be limited to these illustrative examples.

### EXAMPLE 1

In accordance with one embodiment of the invention, the substrate 22 is a monocrystalline silicon substrate oriented in the (100) direction. The substrate 22 can be, for example, a silicon substrate as is commonly used in making complementary metal oxide semiconductor (CMOS) integrated circuits having a diameter of about 200-300 mm. In accordance with this embodiment of the invention, the accommodating buffer layer 24 is a monocrystalline layer of Sr_{z}Ba_{1-z}TiO₃ where z ranges from 0 to 1 and the amorphous intermediate layer 28 is a layer of silicon oxide (SiOₓ) formed at the interface between the silicon substrate 22 and the accommodating buffer layer 24. The value of z is selected to obtain one or more lattice constants closely matched to corresponding lattice constants of the subsequently formed material layer 26. The accommodating buffer layer 24 can have a thickness of about 2 to about 100 nanometers (nm) and preferably has a thickness of about 5 nm. In general, it is desired to have an accommodating buffer layer 24 thick enough to isolate the monocrystalline material layer 26 from the substrate 22 to obtain the desired electrical and optical properties. Layers thicker than 100 nm usually provide little additional benefit while increasing cost unnecessarily; however, thicker layers may be fabricated if needed. The amorphous intermediate layer 28 of silicon oxide can have a thickness of about 0.5-5 nm, and preferably a thickness of about 1 to 2 nm.

In accordance with this embodiment of the invention, the monocrystalline material layer 26 is a compound semiconductor layer of gallium arsenide (GaAs) or aluminum gallium arsenide (AlGaAs) having a thickness of about 1 nm to about 100 micrometers (μm) and preferably a thickness of about 0.5 μm to 10 μm. The thickness generally depends on the application for which the layer is being prepared. To facilitate the epitaxial growth of the gallium arsenide or aluminum gallium arsenide on the monocrystalline oxide, a template layer is formed by capping the oxide layer. The template layer is preferably 1-10 monolayers of Ti—As, Sr—O—As, Sr—Ga—O, or Sr—Al—O. By way of a preferred example, 1-2 monolayers of Ti—As or Sr—Ga—O have been illustrated to successfully grow GaAs layers.

### EXAMPLE 2

In accordance with a further embodiment of the invention, the substrate 22 is a monocrystalline silicon substrate as described above. The accommodating buffer layer 24 is a monocrystalline oxide of strontium or barium zirconate or hafnate in a cubic or orthorhombic phase with an amorphous intermediate layer 28 of silicon oxide formed at the interface between the silicon substrate 22 and the accommodating buffer layer 24. The accommodating buffer layer 24 can have a thickness of about 2-100 nm and preferably has a thickness of at least 5 nm to ensure adequate crystalline and surface quality and is formed of a monocrystalline SrZrO₃, BaZrO₃, SrHfO₃, BaSnO₃ or BaHfO₃. For example, a monocrystalline oxide layer of BaZrO₃ can grow at a temperature of about 700 degrees C. The lattice structure of the resulting crystalline oxide exhibits a 45 degree rotation with respect to the substrate silicon lattice structure.

An accommodating buffer layer formed of these zirconate or hafnate materials is suitable for the growth of a monocrystalline material layer which comprises compound semiconductor materials in the indium phosphide (InP) system. In this system, the compound semiconductor material can be, for example, indium phosphide (InP), indium gallium arsenide (InGaAs), aluminum indium arsenide, (AlInAs), or aluminum gallium indium arsenic phosphide (AlGaInAsP), having a thickness of about 1.0 nm to 10 μm. A suitable template, i.e., the template layer 30, for this structure is 1-10 monolayers of zirconium-arsenic (Zr—As), zirconium-phosphorus (Zr—P), hafnium-arsenic (Hf—As), hafnium-phosphorus (Hf—P), strontium-oxygen-arsenic (Sr—O—As), strontium-oxygen-phosphorus (SrO—P), barium-oxygen-arsenic (Ba—O—As), indium-strontium-oxygen (In—Sr—O), or barium-oxygen-phosphorus (Ba—O—P), and preferably 1-2 monolayers of one of these materials. By way of an example, for a barium zirconate accommodating buffer layer, the surface is terminated with 1-2 monolayers of zirconium followed by deposition of 1-2 monolayers of arsenic to form a Zr—As template. A monocrystalline layer of the compound semiconductor material from the indium phosphide system is then grown on the template layer. The resulting lattice structure of the compound semiconductor material exhibits a 45 degree rotation with respect to the accommodating buffer layer lattice structure and a lattice mismatch to (100) InP of less than 2.5%, and preferably less than about 1.0%.

### EXAMPLE 3

In accordance with a further embodiment of the invention, a structure is provided that is suitable for the growth of an epitaxial film of a monocrystalline material comprising a II-VI material overlying a silicon substrate. The substrate is preferably a silicon wafer as described above. A suitable accommodating buffer layer material is SrₓBa₁₋ₓTiO₃, where x ranges from 0 to 1, having a thickness of about 2-100 nm and preferably a thickness of about 5-15 nm. Where the monocrystalline layer comprises a compound semiconductor material, the II-VI compound semiconductor material can be, for example, zinc selenide (ZnSe) or zinc sulfur selenide (ZnSSe). A suitable template for this material system includes 1-10 monolayers of zinc-oxygen (Zn—O) followed by 1-2 monolayers of an excess of zinc followed by the selenidation of zinc on the surface. Alternatively, a template can be, for example, 1-10 monolayers of strontium-sulfur (Sr—S) followed by the ZnSeS.

### EXAMPLE 4

This embodiment of the invention is an example of the structure 40 illustrated in FIG. 2. The substrate 22, accommodating buffer layer 24, and monocrystalline material layer 26 can be similar to those described in example 1. In addition, an additional buffer layer 32 serves to alleviate any strains that might result from a mismatch of the crystal lattice of the accommodating buffer layer 24 and the lattice of the monocrystalline material. The additional buffer layer 32 can be a layer of germanium or a GaAs, an aluminum gallium arsenide (AlGaAs), an indium gallium phosphide (InGaP), an aluminum gallium phosphide (AlGaP), an indium gallium arsenide (InGaAs), an aluminum indium phosphide (AlInP), a gallium arsenide phosphide (GaAsP), or an indium gallium phosphide (InGaP) strain compensated superlattice. In accordance with one aspect of this embodiment, the additional buffer layer 32 includes a GaAsₓP₁₋ₓ superlattice, where the value of x ranges from 0 to 1. In accordance with another aspect, the additional buffer layer 32 includes an In_{y}Ga_{1-y}P superlattice, where the value of y ranges from 0 to 1. By varying the value of x or y, as the case may be, the lattice constant is varied from bottom to top across the superlattice to create a match between lattice constants of the underlying oxide and the overlying monocrystalline material which in this example is a compound semiconductor material. The compositions of other compound semiconductor materials, such as those listed above, may be similarly varied to manipulate the lattice constant of the additional buffer layer 32 in a like manner. The superlattice can have a thickness of about 50-500 nm and preferably has a thickness of about 100-200 nm. The template for this structure can be the same as that described in example 1. Alternatively, the additional buffer layer 32 can be a layer of monocrystalline germanium having a thickness of 1-50 nm and preferably having a thickness of about 2-20 nm. In using a germanium buffer layer, a template layer of either germanium-strontium (Ge—Sr) or germanium-titanium (Ge—Ti) having a thickness of about one monolayer can be used as a nucleating site for the subsequent growth of the monocrystalline material layer 26 that in this example is a compound semiconductor material. The formation of the oxide layer is capped with either a monolayer of strontium or a monolayer of titanium to act as a nucleating site for the subsequent deposition of the monocrystalline germanium. The monolayer of strontium or titanium provides a nucleating site to which the first monolayer of germanium can bond.

### EXAMPLE 5

This example also illustrates materials useful in the structure 40 illustrated in FIG. 2. The substrate 22, accommodating buffer layer 24, monocrystalline material layer 26 and template layer 30 can be the same as those described above in example 2. The additional buffer layer 32 is inserted between the accommodating buffer layer 24 and the overlying monocrystalline material layer 26. The additional buffer layer 32, a further monocrystalline material that in this instance comprises a semiconductor material, can be, for example, a graded layer of indium gallium arsenide (InGaAs) or indium aluminum arsenide (InAlAs). In accordance with one aspect of this embodiment, the additional buffer layer 32 includes InGaAs, in which the indium composition varies from 0 to about 50%. The additional buffer layer 32 preferably has a thickness of about 10-30 nm. Varying the composition of the additional buffer layer 32 from GaAs to InGaAs serves to provide a lattice match between the underlying monocrystalline oxide material and the overlying layer of monocrystalline material that in this example is a compound semiconductor material. Such a buffer layer is especially advantageous if there is a lattice mismatch between the accommodating buffer layer 24 and the monocrystalline material layer 26.

### EXAMPLE 6

This example provides exemplary materials useful in the structure 34 illustrated in FIG. 3. The substrate 22, template layer 30, and monocrystalline material layer 26 may be the same as those described above in connection with example 1.

The amorphous layer 36 is an amorphous oxide layer that is suitably formed of a combination of amorphous intermediate layer materials (e.g., amorphous intermediate layer 28 materials as described above) and accommodating buffer layer materials (e.g., accommodating buffer layer 24 materials as described above). For example, the amorphous layer 36 may include a combination of SiOₓ and Sr_{z}Ba_{1-z}TiO₃ (where z ranges from 0 to 1), which combine or mix, at least partially, during an anneal process to form the amorphous oxide layer 36.

The thickness of the amorphous layer 36 may vary from application to application and may depend on such factors as desired insulating properties of the amorphous layer 36, type of monocrystalline material of the amorphous layer 26, and the like. In accordance with one exemplary aspect of the present embodiment, the amorphous layer 36 has a thickness of about 2 nm to about 100 nm, preferably about 2-10 nm, and more preferably about 5-6 nm.

The additional monocrystalline layer 38 comprises a monocrystalline material that can be grown epitaxially over a monocrystalline oxide material such as the material used to form the accommodating buffer layer 24. In accordance with one embodiment of the invention, the additional monocrystalline layer 38 includes the same materials as those comprising the amorphous layer 26. For example, if the amorphous layer 26 includes GaAs, the additional monocrystalline layer 38 also includes GaAs. However, in accordance with other embodiments of the present invention, the additional monocrystalline layer 38 may include materials different from those used to form the amorphous layer 26. In accordance with one exemplary embodiment of the invention, the additional monocrystalline layer 38 is about 1 monolayer to about 100 nm thick.

Referring again to FIGS. 1-3, the substrate 22 is a monocrystalline substrate such as a monocrystalline silicon or gallium arsenide substrate. The crystalline structure of the substrate 22 is characterized by a lattice constant and by a lattice orientation. In similar manner, the accommodating buffer layer 24 is also a monocrystalline material, the lattice of which is characterized by a lattice constant and a crystal orientation. The lattice constants of the accommodating buffer layer 24 and the substrate 22 must be closely matched or, alternatively, must be such that upon rotation of one crystal orientation with respect to the other crystal orientation, a substantial match in lattice constants is achieved. In this context the terms “substantially equal” and “substantially matched” mean that there is sufficient similarity between the lattice constants to permit the growth of a high quality crystalline layer on the underlying layer.

FIG. 4 illustrates graphically the relationship of the achievable thickness of a grown crystal layer of high crystalline quality as a function of the mismatch between the lattice constants of the host crystal and the grown crystal. Curve 42 illustrates the boundary of high crystalline quality material. The area to the right of curve 42 represents layers that have a large number of defects. With no lattice mismatch, it is theoretically possible to grow an infinitely thick, high quality epitaxial layer on the host crystal. As the mismatch in lattice constants increases, the thickness of achievable, high quality crystalline layer decreases rapidly. As a reference point, for example, if the lattice constants between the host crystal and the grown layer are mismatched by more than about 2%, monocrystalline epitaxial layers in excess of about 20 nm cannot be achieved.

In accordance with one embodiment of the invention, the substrate 22 is a (100) or (111) oriented monocrystalline silicon wafer and the accommodating buffer layer 24 is a layer of strontium barium titanate. Substantial matching of lattice constants between these two materials is achieved by rotating the crystal orientation of the titanate material by 45° with respect to the crystal orientation of the silicon wafer. The inclusion in the structure of the amorphous intermediate layer 28, a silicon oxide layer in this example, if it is of sufficient thickness, serves to reduce strain in the titanate monocrystalline layer that might result from any mismatch in the lattice constants of the host silicon wafer and the grown titanate layer. As a result, in accordance with an embodiment of the invention, a high quality, thick, monocrystalline titanate layer is achievable.

Still referring to FIGS. 1-3, the material layer 26 is a layer of epitaxially grown monocrystalline material that is characterized by a crystal lattice constant and a crystal orientation. In accordance with one embodiment of the invention, the lattice constant of the material layer 26 differs from the lattice constant of the substrate 22. To achieve high crystalline quality in this epitaxially grown monocrystalline layer, the accommodating buffer layer 24 must be of high crystalline quality. In addition, in order to achieve high crystalline quality in the material layer 26, substantial matching between the crystal lattice constant of the host crystal, in this case, the monocrystalline accommodating buffer layer 24, and the grown crystal is desired. With properly selected materials this substantial matching of lattice constants is achieved as a result of rotation of the crystal orientation of the grown crystal with respect to the orientation of the host crystal. For example, if the grown crystal is gallium arsenide, aluminum gallium arsenide, zinc selenide, or zinc sulfur selenide and the accommodating buffer layer 24 is monocrystalline SrₓBa₁₋ₓTiO₃, substantial matching of crystal lattice constants of the two materials is achieved, where the crystal orientation of the grown layer is rotated by 45° with respect to the orientation of the host monocrystalline oxide. Similarly, if the host material is a strontium or barium zirconate or a strontium or barium hafnate or barium tin oxide and the material layer 26 is indium phosphide or gallium indium arsenide or aluminum indium arsenide, substantial matching of crystal lattice constants can be achieved by rotating the orientation of the grown crystal layer by 45° with respect to the host oxide crystal. In some instances, a crystalline semiconductor buffer layer between the host oxide and the grown monocrystalline material layer 26 can be used to reduce strain in the grown monocrystalline material layer 26 that might result from small differences in lattice constants. Better crystalline quality in the grown monocrystalline material layer 26 can thereby be achieved.

The following example illustrates a process, in accordance with one embodiment of the invention, for fabricating a semiconductor structure such as the structures depicted in FIGS. 1-3. The process starts by providing a monocrystalline semiconductor substrate comprising silicon or germanium. In accordance with a preferred embodiment of the invention, the semiconductor substrate is a silicon wafer having a (100) orientation. The substrate is preferably oriented on axis or, at most, about 4° off axis. At least a portion of the semiconductor substrate has a bare surface, although other portions of the substrate, as described below, may encompass other structures. The term “bare” in this context means that the surface in the portion of the substrate has been cleaned to remove any oxides, contaminants, or other foreign material. As is well known, bare silicon is highly reactive and readily forms a native oxide. The term “bare” is intended to encompass such a native oxide. A thin silicon oxide may also be intentionally grown on the semiconductor substrate, although such a grown oxide is not essential to the process in accordance with the invention. In order to epitaxially grow a monocrystalline oxide layer overlying the monocrystalline substrate, the native oxide layer must first be removed to expose the crystalline structure of the underlying substrate. The following process is preferably carried out by molecular beam epitaxy (MBE), although other epitaxial processes may also be used in accordance with the present invention. The native oxide can be removed by first thermally depositing a thin layer of strontium, barium, a combination of strontium and barium, or other alkaline earth metals or combinations of alkaline earth metals in an MBE apparatus. In the case where strontium is used, the substrate is then heated to a temperature of about 750° C. to cause the strontium to react with the native silicon oxide layer. The strontium serves to reduce the silicon oxide to leave a silicon oxide-free surface. The resultant surface, which exhibits an ordered 2×1 structure, includes strontium, oxygen, and silicon. The ordered 2×1 structure forms a template for the ordered growth of an overlying layer of a monocrystalline oxide. The template provides the necessary chemical and physical properties to nucleate the crystalline growth of an overlying layer.

In accordance with an alternate embodiment of the invention, the native silicon oxide can be converted and the substrate surface can be prepared for the growth of a monocrystalline oxide layer by depositing an alkaline earth metal oxide, such as strontium oxide, strontium barium oxide, or barium oxide, onto the substrate surface by MBE at a low temperature and by subsequently heating the structure to a temperature of about 750° C. At this temperature a solid state reaction takes place between the strontium oxide and the native silicon oxide causing the reduction of the native silicon oxide and leaving an ordered 2×1 structure with strontium, oxygen, and silicon remaining on the substrate surface. Again, this forms a template for the subsequent growth of an ordered monocrystalline oxide layer.

Following the removal of the silicon oxide from the surface of the substrate, in accordance with one embodiment of the invention, the substrate is cooled to a temperature in the range of about 200-800° C. and a layer of strontium titanate is grown on the template layer by molecular beam epitaxy. The MBE process is initiated by opening shutters in the MBE apparatus to expose strontium, titanium and oxygen sources. The ratio of strontium and titanium is approximately 1:1. The partial pressure of oxygen is initially set at a minimum value to grow stoichiometric strontium titanate at a growth rate of about 0.3-0.5 nm per minute. After initiating growth of the strontium titanate, the partial pressure of oxygen is increased above the initial minimum value. The overpressure of oxygen causes the growth of an amorphous silicon oxide layer at the interface between the underlying substrate and the growing strontium titanate layer. The growth of the silicon oxide layer results from the diffusion of oxygen through the growing strontium titanate layer to the interface where the oxygen reacts with silicon at the surface of the underlying substrate. The strontium titanate grows as an ordered (100) monocrystal with the (100) crystalline orientation rotated by 45° with respect the underlying substrate. Strain that otherwise might exist in the strontium titanate layer because of the small mismatch in lattice constant between the silicon substrate and the growing crystal is relieved in the amorphous silicon oxide intermediate layer.

After the strontium titanate layer has been grown to the desired thickness, the monocrystalline strontium titanate is capped by a template layer that is conducive to the subsequent growth of an epitaxial layer of a desired monocrystalline material. For example, for the subsequent growth of a monocrystalline compound semiconductor material layer of gallium arsenide, the MBE growth of the strontium titanate monocrystalline layer can be capped by terminating the growth with 1-2 monolayers of titanium, 1-2 monolayers of titanium-oxygen or with 1-2 monolayers of strontium-oxygen. Following the formation of this capping layer, arsenic is deposited to form a Ti—As bond, a Ti—O—As bond or a Sr—O—As. Any of these form an appropriate template for deposition and formation of a gallium arsenide monocrystalline layer. Following the formation of the template, gallium is subsequently introduced to the reaction with the arsenic and gallium arsenide forms. Alternatively, gallium can be deposited on the capping layer to form a Sr—O—Ga bond, and arsenic is subsequently introduced with the gallium to form the GaAs.

FIG. 5 is a high resolution Transmission Electron Micrograph (TEM) of semiconductor material manufactured in accordance with one embodiment of the present invention. Single crystal SrTiO₃ accommodating buffer layer 24 was grown epitaxially on silicon substrate 22. During this growth process, the amorphous intermediate layer 28 is formed, which relieves strain due to lattice mismatch. The monocrystalline material layer 26 formed of a GaAs compound semiconductor material was then grown epitaxially using the template layer 30.

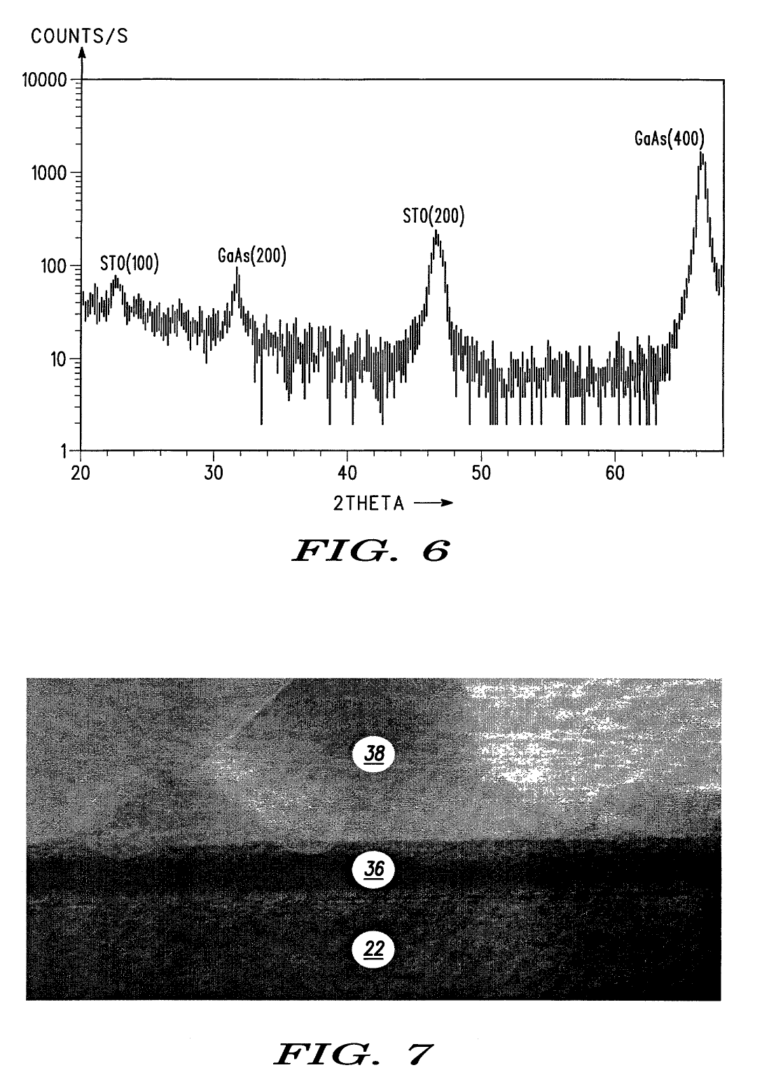

FIG. 6 illustrates an x-ray diffraction spectrum taken on a structure including the monocrystalline material layer 26 comprising GaAs grown on the silicon substrate 22 using the accommodating buffer layer 24. The peaks in the spectrum indicate that both the accommodating buffer layer 24 and the GaAs monocrystalline material layer 26 are single crystal and (100) orientated.

The structure 40 illustrated in FIG. 2 can be formed by the process discussed above with the addition of an additional buffer layer deposition step. The additional buffer layer 32 is formed overlying the template layer 30 before the deposition of the monocrystalline material layer 26. If the additional buffer layer 32 is a monocrystalline material comprising a compound semiconductor superlattice, such a superlattice can be deposited, by MBE for example, on the template layer 30 described above. If instead the additional buffer layer 32 is a monocrystalline material layer comprising a layer of germanium, the process above is modified to cap the strontium titanate monocrystalline layer with a final layer of either strontium or titanium and then by depositing germanium to react with the strontium or titanium. The germanium additional buffer layer 32 can then be deposited directly on this template.

The structure 34 illustrated in FIG. 3 may be formed by growing the accommodating buffer layer 24, forming an amorphous oxide layer over the substrate 22, and growing the additional monocrystalline layer 38 over the accommodating buffer layer 24, as described above. The accommodating buffer layer 24 and the amorphous oxide layer 28 are then exposed to an anneal process sufficient to change the crystalline structure of the accommodating buffer layer 24 from monocrystalline to amorphous, thereby forming an amorphous layer such that the combination of the amorphous oxide layer 28 and the now amorphous accommodating buffer layer 24 form a single amorphous oxide layer 36. The monocrystalline material layer 26 is then grown over the additional monocrystalline layer 38. Alternatively, the anneal process may be carried out subsequent to growth of the monocrystalline material layer 26.

In accordance with one aspect of this embodiment, the amorphous layer 36 is formed by exposing the substrate 22, the accommodating buffer layer 24, the amorphous oxide layer 28, and the additional monocrystalline layer 38 to a rapid thermal anneal process with a peak temperature of about 700° C. to about 1000° C. and a process time of about 5 seconds to about 10 minutes. However, other suitable anneal processes may be employed to convert the accommodating buffer layer 24 to an amorphous layer in accordance with the present invention. For example, laser annealing, electron beam annealing, or “conventional” thermal annealing processes (in the proper environment) may be used to form the amorphous layer 36. When conventional thermal annealing is used to form the amorphous layer 36, an overpressure of one or more constituents of the template layer 30 may be required to prevent degradation of the additional monocrystalline layer 38 during the anneal process. For example, when the additional layer 38 includes GaAs, the anneal environment preferably includes an overpressure of arsenic to mitigate degradation of the additional layer 38.

As noted above, the additional layer 38 of the structure 34 may include any materials suitable for either of the additional buffer layer 32 or the monocrystalline material layer 26. Accordingly, any deposition or growth methods described in connection with either the additional buffer layer 32 or the monocrystalline material layer 26, may be used to deposit the additional layer 38.

FIG. 7 is a high resolution TEM of semiconductor material manufactured in accordance with the embodiment of the invention illustrated in FIG. 3. In accordance with this embodiment, a single crystal SrTiO₃ accommodating buffer layer 24 was grown epitaxially on the silicon substrate 22. During this growth process, an amorphous intermediate layer forms as described above. Next, the additional monocrystalline layer 38 comprising a compound semiconductor layer of GaAs is formed above the accommodating buffer layer 24 and the accommodating buffer layer 24 is exposed to an anneal process to form the amorphous oxide layer 36.

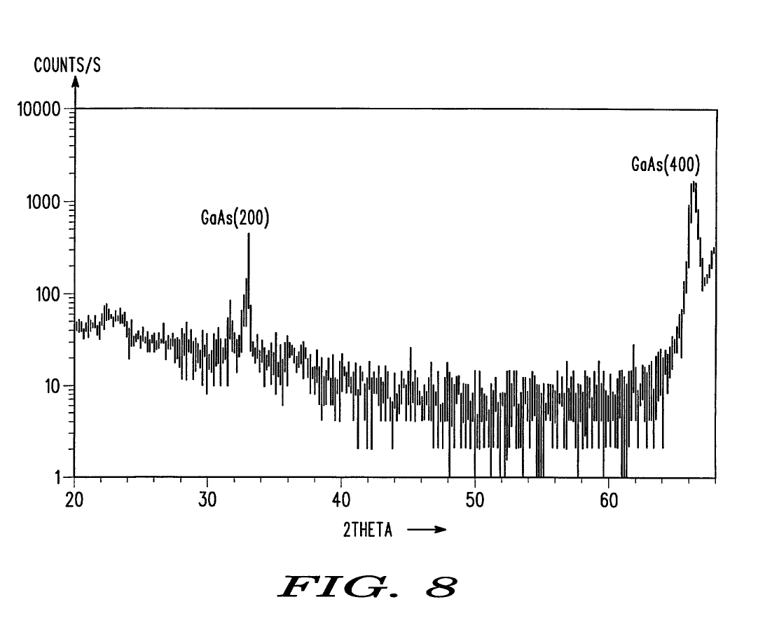

FIG. 8 illustrates an x-ray diffraction spectrum taken on a structure including the additional monocrystalline layer 38 comprising a GaAs compound semiconductor layer and the amorphous oxide layer 36 formed on the silicon substrate 22. The peaks in the spectrum indicate that the GaAs compound semiconductor layer 38 is single crystal and (100) orientated and the lack of peaks around 40 to 50 degrees indicates that the amorphous layer 36 is indeed amorphous.

The process described above illustrates a process for forming a semiconductor structure including a silicon substrate, an overlying oxide layer, and a monocrystalline material layer comprising a gallium arsenide compound semiconductor layer by the process of MBE. The process can also be carried out by the process of chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like. Further, by a similar process, other monocrystalline accommodating buffer layers such as alkaline earth metal titanates, zirconates, hafnates, tantalates, vanadates, ruthenates, and niobates, alkaline earth metal tin-based perovskites, lanthanum aluminate, lanthanum scandium oxide, and gadolinium oxide can also be grown. Further, by a similar process such as MBE, other monocrystalline material layers comprising other III-V and II-VI monocrystalline compound semiconductors, semiconductors, metals and non-metals can be deposited overlying the monocrystalline oxide accommodating buffer layer.

Each of the variations of the monocrystalline material layer 26 and the monocrystalline oxide accommodating buffer layer 24 uses an appropriate template layer 30 for initiating the growth of the monocrystalline material layer 26. For example, if the accommodating buffer layer 24 is an alkaline earth metal zirconate, the oxide can be capped by a thin layer of zirconium. The deposition of zirconium can be followed by the deposition of arsenic or phosphorus to react with the zirconium as a precursor to depositing indium gallium arsenide, indium aluminum arsenide, or indium phosphide respectively. Similarly, if the monocrystalline oxide accommodating buffer layer 24 is an alkaline earth metal hafnate, the oxide layer can be capped by a thin layer of hafnium. The deposition of hafnium is followed by the deposition of arsenic or phosphorous to react with the hafnium as a precursor to the growth of an indium gallium arsenide, indium aluminum arsenide, or indium phosphide layer, respectively. In a similar manner, strontium titanate can be capped with a layer of strontium or strontium and oxygen and barium titanate can be capped with a layer of barium or barium and oxygen. Each of these depositions can be followed by the deposition of arsenic or phosphorus to react with the capping material to form the template layer 30 for the deposition of the monocrystalline material layer 26 comprising compound semiconductors such as indium gallium arsenide, indium aluminum arsenide, or indium phosphide.

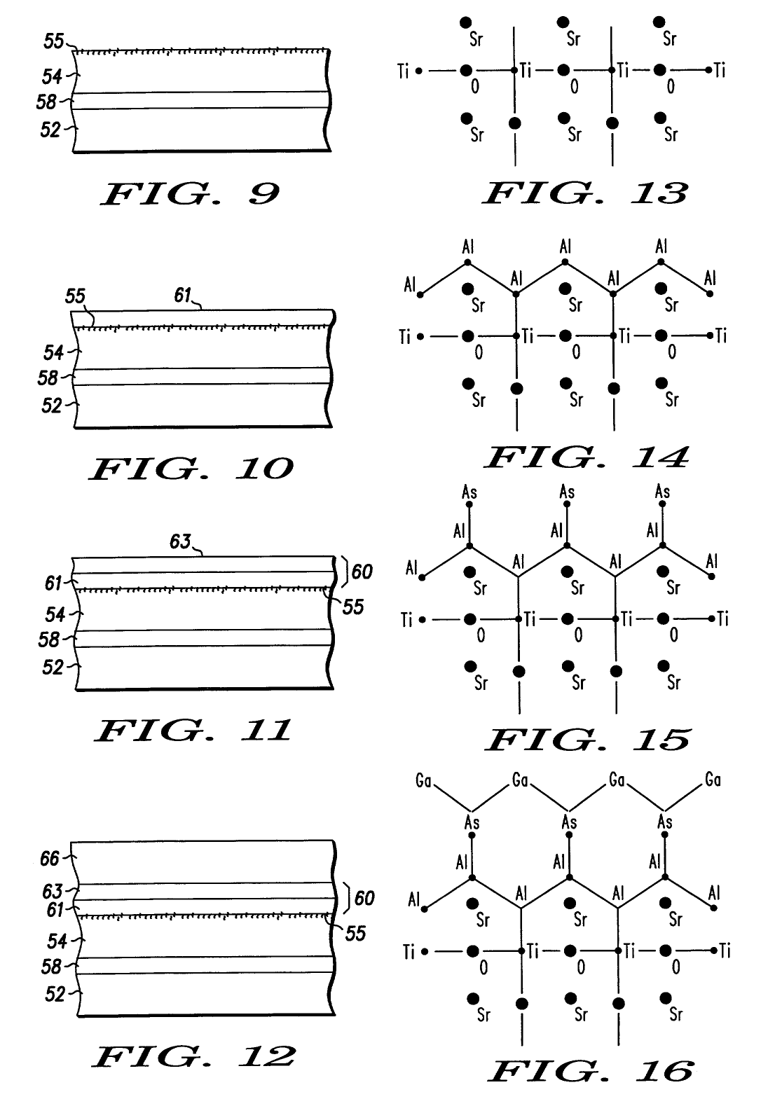

The formation of a device structure in accordance with another embodiment of the invention is illustrated schematically in cross-section in FIGS. 9-12. Like the previously described embodiments referred to in FIGS. 1-3, this embodiment of the invention involves the process of forming a compliant substrate utilizing the epitaxial growth of single crystal oxides, such as the formation of the accommodating buffer layer 24 previously described with reference to FIGS. 1 and 2 and the amorphous layer 36 previously described with reference to FIG. 3, and the formation of the template layer 30. However, the embodiment illustrated in FIGS. 9-12 utilizes a template that includes a surfactant to facilitate layer-by-layer monocrystalline material growth.

Referring now to FIG. 9, an amorphous intermediate layer 58 is grown on a substrate 52 at the interface between the substrate 52 and a growing accommodating buffer layer 54, which is preferably a monocrystalline crystal oxide layer, by the oxidation of the substrate 52 during the growth of the accommodating buffer layer 54. The accommodating buffer layer 54 is preferably a monocrystalline oxide material such as a monocrystalline layer of Sr_{z}Ba_{1-z}TiO₃ where z ranges from 0 to 1. However, the accommodating buffer layer 54 may also comprise any of those compounds previously described with reference to the accommodating buffer layer 24 in FIGS. 1-2 and any of those compounds previously described with reference to the amorphous layer 36 in FIG. 3 that is formed from the accommodating buffer layer 24 and the amorphous intermediate layer 28 referenced in FIGS. 1 and 2.

The accommodating buffer layer 54 is grown with a strontium (Sr) terminated surface represented in FIG. 9 by hatched line 55 which is followed by the addition of a template layer 60 that includes a surfactant layer 61 and a capping layer 63 as illustrated in FIGS. 10 and 11. The surfactant layer 61 may comprise, but is not limited to, elements such as Al, In and Ga, but will be dependent upon the composition of the accommodating buffer layer 54 and an overlying layer 66 (FIG. 12) of monocrystalline material for optimal results. In one exemplary embodiment, aluminum (Al) is used for the surfactant layer 61, which functions to modify the surface and surface energy of the accommodating buffer layer 54. Preferably, the surfactant layer 61 is epitaxially grown, to a thickness of one to two monolayers, over the accommodating buffer layer 54, as illustrated in FIG. 10, by way of MBE, although other epitaxial processes may also be performed including CVD, MOCVD, MEE, ALE, PVD, CSD, PLD, or the like.

The surfactant layer 61 is then exposed to a Group V element such as arsenic, for example, to form the capping layer 63 illustrated in FIG. 11. The surfactant layer 61 may be exposed to a number of materials to create the capping layer 63 such as elements that include, but are not limited to, As, P, Sb and N. The surfactant layer 61 and the capping layer 63 combine to form the template layer 60.

The overlying monocrystalline material layer 66, which in this example is a compound semiconductor material such as GaAs, is then deposited via MBE, CVD, MOCVD, MEE, ALE, PVD, CSD, PLD, and the like to form the final structure illustrated in FIG. 12.

FIGS. 13-16 illustrate possible molecular bond structures for a specific example of a compound semiconductor structure formed in accordance with the embodiment of the invention illustrated in FIGS. 9-12. More specifically, FIGS. 13-16 illustrate the growth of GaAs (layer 66) on the strontium terminated surface of a strontium titanate monocrystalline oxide (layer 54) using a surfactant containing template (layer 60).

The growth of a monocrystalline material layer 66, such as GaAs, on the accommodating buffer layer 54 such as a strontium titanium oxide over the amorphous intermediate layer 58 and the substrate 52, both of which may comprise materials previously described with reference to the amorphous intermediate layer 28 and the substrate 22, respectively in FIGS. 1 and 2, illustrates a critical thickness of about 1000 Angstroms where the two-dimensional (2D) and three-dimensional (3D) growth shifts because of the surface energies involved. In order to maintain a true layer-by-layer growth (Frank Van der Mere growth), the following relationship must be satisfied:

δ_{STO}>(δ_{INT}+δ_{GaAs})

where the surface energy of the monocrystalline oxide accommodating buffer layer 54 must be greater than the surface energy of the amorphous interface layer 58 added to the surface energy of the GaAs monocrystalline material layer 66. Since it is impracticable to satisfy this equation, a surfactant containing template was used, as described above with reference to FIGS. 10-12, to increase the surface energy of the monocrystalline oxide accommodating buffer layer 54 and also to shift the crystalline structure of the template to a diamond-like structure that is in compliance with the original GaAs layer.

FIG. 13 illustrates the molecular bond structure of a strontium terminated surface of a strontium titanate monocrystalline oxide layer (layer 54). An aluminum surfactant layer (layer 61) is deposited on top of the strontium terminated surface 55 and bonds with the surface 55 as illustrated in FIG. 14, which reacts to form the capping layer 63 comprising a monolayer of Al₂Sr having the molecular bond structure illustrated in FIG. 14 which forms a diamond-like structure with an sp³ hybrid terminated surface that is compliant with compound semiconductors such as GaAs. The structure is then exposed to As to form a layer of AlAs as shown in FIG. 15. GaAs is then deposited to complete the molecular bond structure illustrated in FIG. 16 that has been obtained by 2D growth. The GaAs can be grown to any thickness for forming other semiconductor structures, devices, or integrated circuits. Alkaline earth metals such as those in Group IIA are those elements preferably used to form the capping surface of the monocrystalline oxide layer 54 because they are capable of forming a desired molecular structure with aluminum.

In this embodiment, a surfactant containing template layer (layer 60) aids in the formation of a compliant substrate for the monolithic integration of various material layers including those comprised of Group III-V compounds to form high quality semiconductor structures, devices and integrated circuits. For example, a surfactant containing template may be used for the monolithic integration of a monocrystalline material layer such as a layer comprising Germanium (Ge), for example, to form high efficiency photocells.

Turning now to FIGS. 17-20, the formation of a device structure in accordance with still another embodiment of the invention is illustrated in cross-section. This embodiment utilizes the formation of a compliant substrate that relies on the epitaxial growth of single crystal oxides on silicon followed by the epitaxial growth of single crystal silicon onto the oxide.

An accommodating buffer layer 74 such as a monocrystalline oxide layer is first grown on a substrate 72, such as silicon, with an amorphous interface layer 78 as illustrated in FIG. 17. The monocrystalline oxide accommodating buffer layer 74 may comprise any of those materials previously discussed with reference to the accommodating buffer layer 24 in FIGS. 1 and 2, while the amorphous interface layer 78 preferably comprises any of those materials previously described with reference to the amorphous intermediate layer 28 illustrated in FIGS. 1 and 2. The substrate 72, although preferably silicon, may also comprise any of those materials previously described with reference to the substrate 22 in FIGS. 1-3.

Next, a silicon layer 81 is deposited over the monocrystalline oxide accommodating buffer layer 74 via MBE, CVD, MOCVD, MEE, ALE, PVD, CSD, PLD, and the like as illustrated in FIG. 18 with a thickness of a few hundred Angstroms, but preferably with a thickness of about 50 Angstroms. The monocrystalline oxide accommodating buffer layer 74 preferably has a thickness of about 20 to 100 Angstroms.

Rapid thermal annealing is then conducted in the presence of a carbon source such as acetylene or methane, for example at a temperature within a range of about 800° C. to 1000° C. to form a capping layer 82 and a silicate amorphous layer 84. However, other suitable carbon sources may be used as long as the rapid thermal annealing step amorphizes the monocrystalline oxide accommodating buffer layer 74 into the silicate amorphous layer 84 and carbonizes the silicon layer 81 to form the capping layer 82, which in this example is a silicon carbide (SiC) layer as illustrated in FIG. 19. The formation of the amorphous layer 84 is similar to the formation of the amorphous layer 36 illustrated in FIG. 3 and may comprise any of those materials described with reference to the amorphous layer 36 in FIG. 3, but the preferable material will be dependent upon the capping layer 82.

Finally, a compound semiconductor layer 86, such as gallium nitride (GaN) is grown over the SiC surface of the capping layer 82 by way of MBE, CVD, MOCVD, MEE, ALE, PVD, CSD, PLD, or the like to form a high quality compound semiconductor material for device formation. More specifically, the deposition of GaN and GaN based systems such as GaInN and AlGaN will result in the formation of dislocation nets confined at the silicon/amorphous region. The resulting nitride containing compound semiconductor material may comprise elements from groups III, IV and V of the periodic table and is defect free.

Although GaN has been grown on SiC substrates in the past, this embodiment of the invention possesses a one step formation of the compliant substrate containing a SiC top surface (capping layer 82) and an amorphous layer (layer 84) on a Si surface (substrate 72). More specifically, this embodiment of the invention uses an intermediate single crystal oxide layer that is amorphosized to form a silicate layer that adsorbs the strain between the layers. Moreover, unlike past use of a SiC substrate, this embodiment of the invention is not limited by wafer size which is usually less than 50 mm in diameter for prior art SiC substrates.

The monolithic integration of nitride containing semiconductor compounds containing group III-V nitrides and silicon devices can be used for high temperature RF applications and optoelectronics. GaN systems have particular use in the photonic industry for the blue/green and UV light sources and detection. High brightness light emitting diodes (LEDs) and lasers may also be formed within the GaN system, as will be discussed in more detail below.

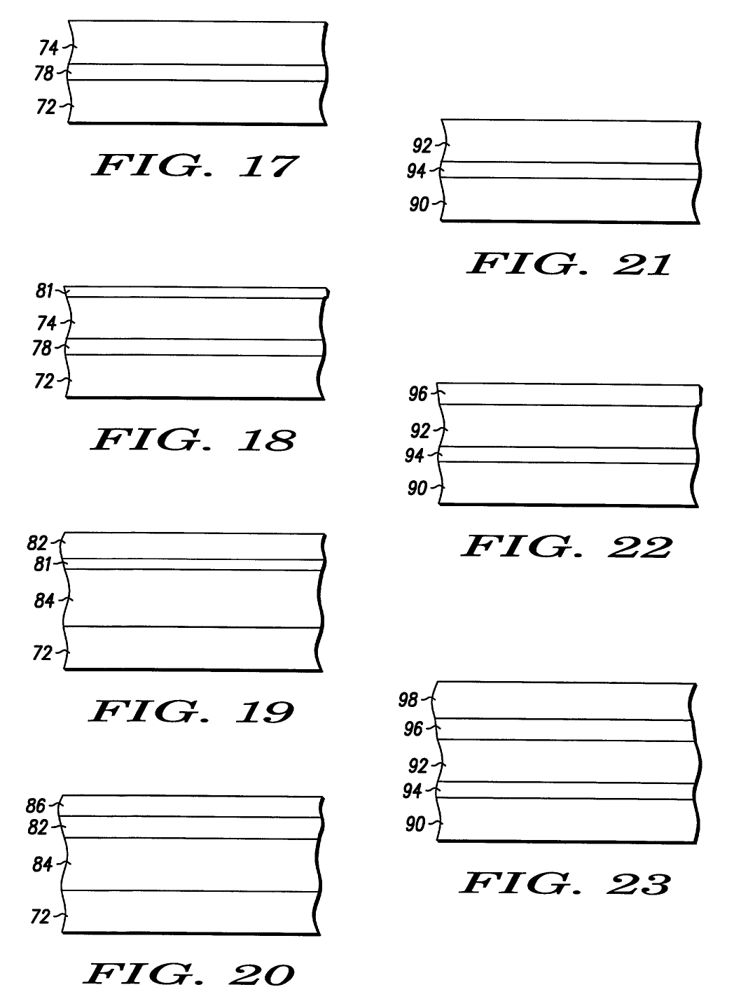

FIGS. 21-23 schematically illustrate, in cross-section, the formation of another embodiment of a device structure in accordance with the invention. This embodiment includes a compliant layer that functions as a transition layer that uses clathrate or Zintl type bonding. More specifically, this embodiment utilizes an intermetallic template layer to reduce the surface energy of the interface between material layers thereby allowing for two dimensional layer by layer growth.

The structure illustrated in FIG. 21 includes a monocrystalline substrate 90, an accommodating buffer layer 92 and an amorphous intermediate layer 94. The amorphous intermediate layer 94 is grown on the substrate 90 at the interface between the substrate 90 and the accommodating buffer layer 92 as previously described with reference to FIGS. 1 and 2. The amorphous intermediate layer 94 may comprise any of those materials previously described with reference to the amorphous interface layer 28 in FIGS. 1 and 2 but preferably comprises a monocrystalline oxide material such as a monocrystalline layer of Sr_{z}Ba_{1-z}TiO₃ where z ranges from 0 to 1. The substrate 90 is preferably silicon but may also comprise any of those materials previously described with reference to the substrate 22 in FIGS. 1-3.

A template layer 96 is deposited over the accommodating buffer layer 92 as illustrated in FIG. 22 and preferably comprises a thin layer of Zintl type phase material composed of metals and metalloids having a great deal of ionic character. As in previously described embodiments, the template layer 96 is deposited by way of MBE, CVD, MOCVD, MEE, ALE, PVD, CSD, PLD, or the like to achieve a thickness of one monolayer. The template layer 96 functions as a “soft” layer with non-directional bonding but high crystallinity that absorbs stress build up between layers having lattice mismatch. Materials for the template layer 96 may include, but are not limited to, materials containing Si, Ga, In, and Sb, such as, for example, AlSr₂, (MgCaYb)Ga₂, (Ca,Sr,Eu,Yb)In₂, BaGe₂As, and SrSn₂As₂

A monocrystalline material layer 98 is epitaxially grown over the template layer 96 to achieve the final structure illustrated in FIG. 23. As a specific example, an SrAl₂ layer may be used as the template layer 96 and an appropriate monocrystalline material layer 98 such as a compound semiconductor material GaAs is grown over the SrAl₂. The Al—Ti (from the accommodating buffer layer 92 of layer of Sr_{z}Ba_{1-z}TiO₃ where z ranges from 0 to 1) bond is mostly metallic while the Al—As (from the GaAs layer) bond is weakly covalent. The Sr participates in two distinct types of bonding with part of its electric charge going to the oxygen atoms in the accommodating buffer layer 92 to participate in ionic bonding and the other part of its valence charge being donated to Al in a way that is typically carried out with Zintl phase materials. The amount of the charge transfer depends on the relative electronegativity of elements of the template layer 96 as well as on the interatomic distance. In this example, Al assumes an sp hybridization and can readily form bonds with the monocrystalline material layer 98, which in this example, comprises compound semiconductor material GaAs.

The compliant substrate produced by use of the Zintl type template layer 96 used in this embodiment can absorb a large strain without a significant energy cost. In the above example, the bond strength of the Al is adjusted by changing the volume of the SrAl₂ of the template layer 96 thereby making the device tunable for specific applications that include the monolithic integration of III-V and Si devices and the monolithic integration of high-k dielectric materials for CMOS technology.

The embodiments specifically describing structures having compound semiconductor portions and Group IV semiconductor portions are meant to illustrate embodiments of the present invention and not limit the present invention. There are a multiplicity of other combinations and other embodiments of the present invention. For example, the present invention includes structures and methods for fabricating material layers that form semiconductor structures, devices and integrated circuits including other layers such as metal and non-metal layers. More specifically, the invention includes structures and methods for forming a compliant substrate that is used in the fabrication of semiconductor structures, devices and integrated circuits and the material layers suitable for fabricating those structures, devices, and integrated circuits. By using embodiments of the present invention, it is relatively easy to integrate devices that include monocrystalline layers of semiconductor and compound semiconductor materials as well as other material layers that are used to form those devices with other components that can be formed within semiconductor or compound semiconductor materials. This allows a reduction in device size, a decrease in the manufacturing costs, and an increase in both yield and reliability to be achieved.

In accordance with one embodiment of this invention, a monocrystalline semiconductor or compound semiconductor wafer can be used in forming monocrystalline material layers over the wafer. In this manner, the wafer is essentially a “handle” wafer used during the fabrication of semiconductor electrical components within a monocrystalline layer overlying the wafer. Therefore, electrical components can be formed within semiconductor materials over a wafer of at least approximately 200 millimeters in diameter and possibly at least approximately 300 millimeters in diameter.

By the use of this type of substrate, a relatively inexpensive “handle” wafer overcomes the fragile nature of compound semiconductor or other monocrystalline material wafers by placing them over a relatively more durable and easy to fabricate base material. Therefore, an integrated circuit can be formed such that all electrical components, and particularly all active electronic devices, can be formed within or using the monocrystalline material layer even though the substrate itself may include a monocrystalline semiconductor material. Fabrication costs for compound semiconductor devices and other devices employing non-silicon monocrystalline materials are decreased because larger substrates can be processed more economically and more readily compared to the relatively smaller and more fragile conventional substrates.

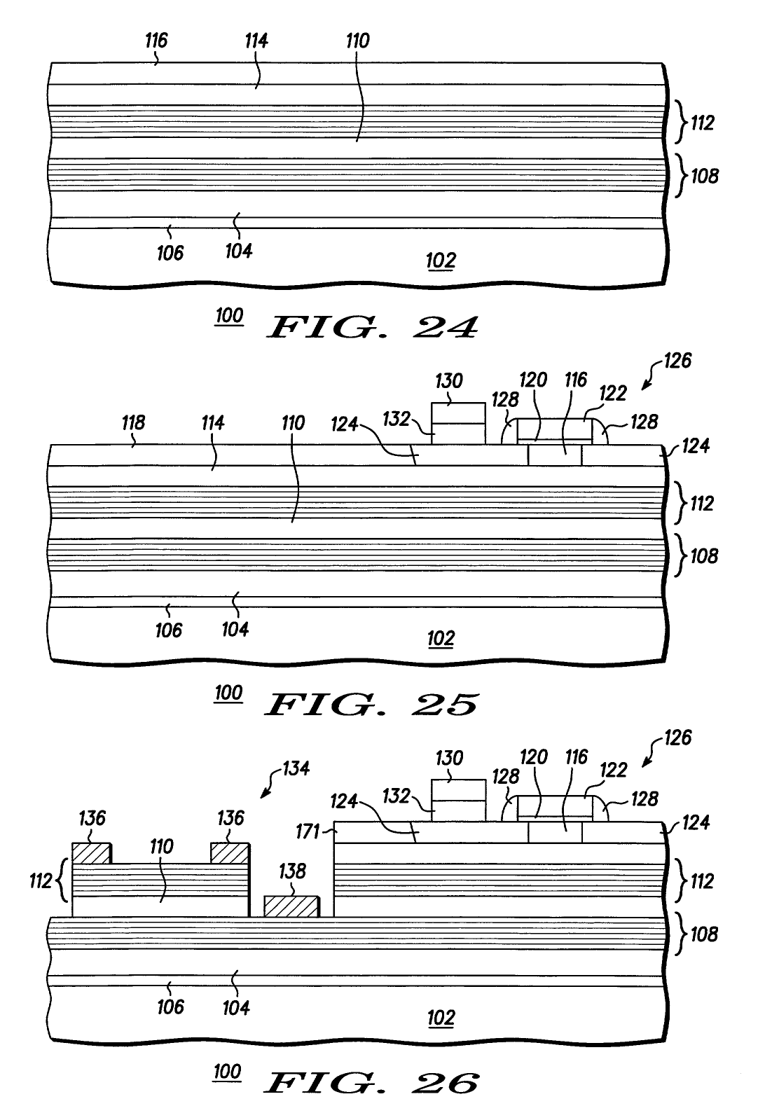

Referring now to FIGS. 24-30, an example of a light source, such as a laser or light emitting diode implemented using the above-described technology is disclosed. That is, an integrated circuit can be formed such that it includes an optical laser in a compound semiconductor portion and an optical interconnect or waveguide to a MOS transistor within a Group IV semiconductor region of the same integrated circuit. The light source may be configured to transmit and receive electromagnetic radiation of various wavelengths. However, the invention is described below for convenience in the context of transmitting light having a wavelength or wavelengths between the infrared and ultraviolet regions of light.

FIG. 24 is a cross-sectional view of a portion of an integrated circuit 100 that includes a monocrystalline silicon wafer 102. A first accommodating buffer layer 104 and an amorphous intermediate layer 106, similar to those previously described, are formed over the wafer 102. The first accommodating buffer layer 104 and the amorphous intermediate layer 106 may be subject to an annealing process as described above in connection with FIG. 3 to form a single amorphous accommodating layer. In this specific embodiment, the layers needed to form the optical laser are formed first, followed by the layers needed for the waveguide and the MOS transistor.

In FIG. 24, a lower mirror layer 108 includes alternating layers of compound semiconductor materials, as is understood by those of ordinary skill in the art. For example, the lower mirror layer 108 may include first, third, and fifth films of a material such as gallium arsenide, and second, fourth, and sixth films of a material such as aluminum gallium arsenide or vice versa. An active layer 110 includes an active region that will be used for photon generation. An upper mirror layer 112 is formed in a similar manner to the lower mirror layer 108 and includes alternating films of compound semiconductor materials. In one particular embodiment, the upper mirror layer 112 may be p-type doped compound semiconductor materials and the lower mirror layer 108 may be n-type doped compound semiconductor materials.

A second accommodating buffer layer 114, similar to the first accommodating buffer layer 104, is formed over the upper mirror layer 112. In an alternative embodiment, the first and second accommodating buffer layers 104 and 114 may include different materials. However, their function is essentially the same in that each is used for making a transition between a compound semiconductor layer and a monocrystalline Group IV semiconductor layer. The second accommodating buffer layer 114 may be subject to an annealing process as described above in connection with FIG. 3 to form an amorphous accommodating layer. A monocrystalline Group IV semiconductor layer 116 is formed over the second accommodating buffer layer 114. In one particular embodiment, the monocrystalline Group IV semiconductor layer 116 includes germanium, silicon germanium, silicon germanium carbide, or the like.

In FIG. 25, the MOS portion is processed to form electrical components within the upper monocrystalline Group IV semiconductor layer 116. As illustrated in FIG. 25, a field isolation region 118 is formed from a portion of the semiconductor layer 116. A gate dielectric layer 120 is formed over the semiconductor layer 116, and a gate electrode 122 is formed over the gate dielectric layer 120. Doped regions 124 are source, drain, or source/drain regions for a transistor 126, as shown. As will be understood by those of skill in the art, the transistor 126 is a MOSFET. Sidewall spacers 128 are formed adjacent to the vertical sides of the gate electrode 122. Other components can be made within at least a part of the semiconductor layer 116. These other components may include other transistors (n-channel or p-channel), capacitors, transistors, diodes, and the like.

Another monocrystalline Group IV semiconductor layer is epitaxially grown over one of the doped regions 124. An upper portion 130 is P+ doped, and a lower portion 132 remains substantially intrinsic (undoped) as illustrated in FIG. 25. The semiconductor layer can be formed using a selective epitaxial process. In one embodiment, an insulating layer (not shown) is formed over the transistor 126 and the field isolation region 118. The insulating layer is patterned to define an opening that exposes one of the doped regions 124. At least initially, the selective epitaxial layer is formed without dopants. The entire selective epitaxial layer may be intrinsic, or a p-type dopant can be added near the end of the formation of the selective epitaxial layer. If the selective epitaxial layer is intrinsic, as formed, a doping step may be formed by implantation or by furnace doping. Regardless how the P+ upper portion 130 is formed, the insulating layer is removed to form the resulting structure shown in FIG. 25.

The next set of steps is performed to define an optical laser 134 as illustrated in FIG. 26. The field isolation region 118 and the second accommodating buffer layer 114 are removed over the compound semiconductor portion of the integrated circuit 100. Additional steps are performed to define the upper mirror layer 112 and active layer 110 of the optical laser 134. The sides of the upper mirror layer 112 and active layer 110 are substantially coterminous.

First and second contacts 136 and 138 are formed for making electrical contact to the upper mirror layer 112 and the lower mirror layer 108, respectively, as shown in FIG. 26. The first contact 136 has an annular shape to allow light (photons) to pass out of the upper mirror layer 112 into a subsequently formed optical waveguide.

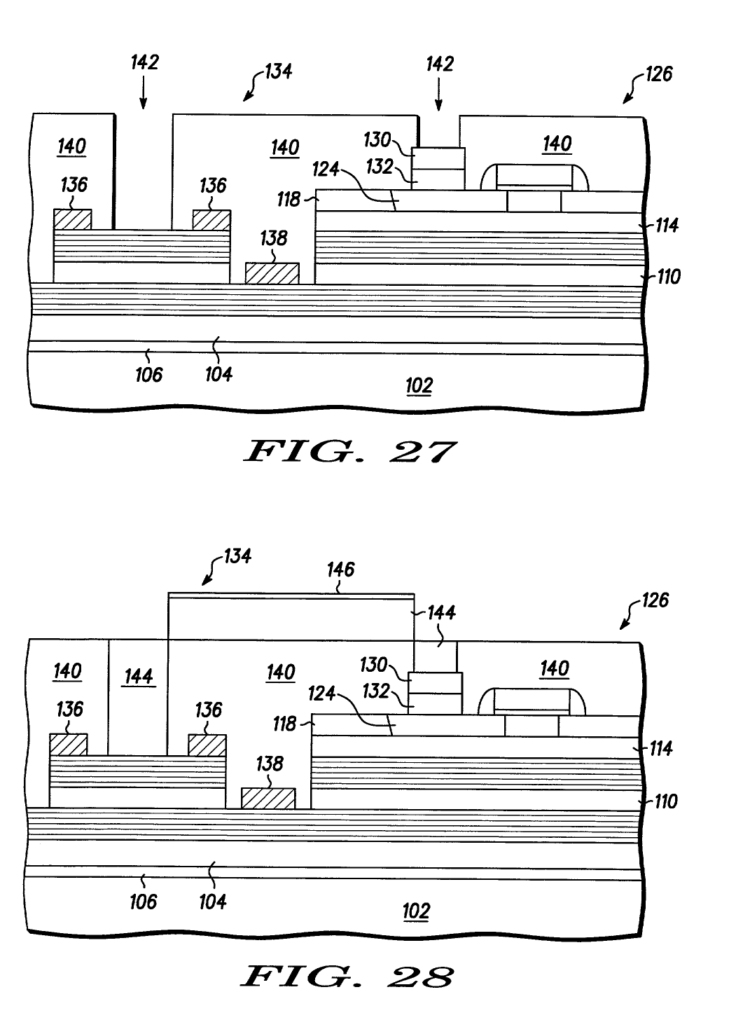

Referring now to FIG. 27, an insulating layer 140 is then formed and patterned to define optical openings extending to the first contact 136 and one of the doped regions 124. The insulating layer 140 can be any number of different materials, including an oxide, nitride, oxynitride, low-k dielectric, or any combination thereof. After defining openings 142, a high refractive index material 144 is formed within the openings 142 to fill them and to deposit the high refractive index material 144 over the insulating layer 140, as illustrated in FIG. 28. With respect to the high refractive index material 144, “high” is in relation to the material of the insulating layer 140. That is, the high refractive index material 144 has a higher refractive index than the material of the insulating layer 140. Optionally, a relatively thin lower refractive index film (not shown) could be formed before forming the high refractive index material 144. A hard mask layer 146 is then formed over the high refractive index material 144. Portions of the hard mask layer 146 and the high refractive index material 144 are removed from portions overlying the opening 142 and to areas closer to the sides of FIG. 28.

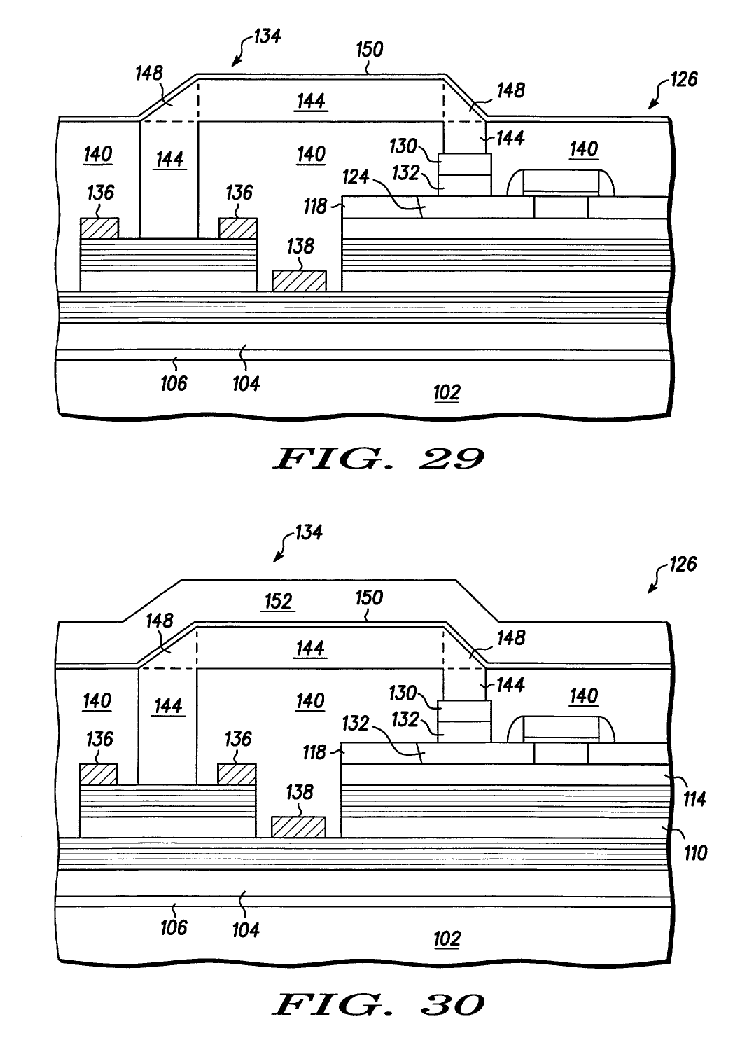

The balance of the formation of the optical waveguide, which is an optical interconnect, is completed as illustrated in FIG. 29. A deposition procedure, for example a dep-etch process, is performed to create sidewalls sections 148. In this embodiment, the sidewall sections 148 are made of the same material as the high refractive index material 144. The hard mask layer 146 is then removed, and a low refractive index layer 150 is formed over the high refractive index material 144 and the sidewall sections 144 and exposed portions of the insulating layer 140. The material of the low refractive index layer 150 has a refractive index that is lower than the refractive index of the high refractive index material 144 and the sidewall sections 148. The dash lines in FIG. 29 illustrate the border between the high refractive index material 144 and the sidewall sections 148. This designation is used to identify that both are made of the same material but are formed at different times.

Processing is continued to form a substantially completed integrated circuit as illustrated in FIG. 30. A passivation layer 152 is then formed over the optical laser 134 and MOSFET transistor 126. Although not shown, other electrical or optical connections are made to the components within the integrated circuit 100 but are not illustrated in FIG. 30. These interconnects can include other optical waveguides or may include metallic interconnects.

Further, in order to boost the strength of any optical signals passing through the optical interconnect, an amplifier can be connected between the optical interconnect and an output port of the optical interconnect. Such an amplifier may be formed, for instance, by a dep-etch process that adds an amplification material layer near the optical openings. Amplification materials, such as Erbium or Neodymium, are known to those of skill in the art.

In other embodiments, other types of lasers can be formed. For example, another type of laser can emit light (photons) horizontally instead of vertically. If light is emitted horizontally, the transistor 126 could be formed within the substrate 102, and the optical waveguide would be reconfigured, so that the laser is properly coupled (optically connected) to the transistor 126. Other configurations, such as a Fabry-Perot type semiconductor laser diode or an LED are also possible. In the Fabry Perot type laser diode, wavelengths are selected using a light interference pattern produced by precisely spaced and parallel surfaces. LEDs emit incoherent light at the junction between p- and n-doped materials, by spontaneous emission. In one specific embodiment, the optical waveguide can include at least a portion of the second accommodating buffer layer 114.

Clearly, these embodiments of integrated circuits having compound semiconductor portions and Group IV semiconductor portions are not intended to be exhaustive of all possibilities or to limit the present invention. There is a multiplicity of other possible combinations and embodiments. For example, the compound semiconductor portion may include light emitting diodes, photodetectors, diodes, or the like, and the Group IV semiconductor can include digital logic, memory arrays, and most structures that can be formed in conventional MOS integrated circuits. By using the technology shown and described herein, it is possible to integrate devices that work well in compound semiconductor materials with other components that work well in Group IV semiconductor materials. This allows for small size devices to be manufactured at low cost with high yield and reliability.

A composite integrated circuit may include components that provide electrical isolation when electrical signals are applied to the composite integrated circuit. The composite integrated circuit may include a pair of optical components, such as an optical source component and an optical detector component. An optical source component may be a light generating semiconductor device, such as an optical laser like the optical laser 134 illustrated in FIG. 29, a photo emitter, a diode, etc. An optical detector component may be a light-sensitive semiconductor junction device, such as a photodetector, a photodiode, a bipolar junction, a transistor, etc. If desired, a plurality of optical components may be included in the composite integrated circuit for providing a plurality of communications connections and for providing isolation. For example, a composite integrated circuit receiving a plurality of data bits may include a pair of optical components for each data bit.

In operation, for example, an optical source component in a pair of components may be configured to generate light, photons, based on receiving electrical signals from an electrical signal connection with the external circuitry. An optical detector component in the pair of components may be optically connected to the source component to generate electrical signals based on detecting light generated by the optical source component. Information that is communicated between the source and detector components may be digital or analog.

The reverse of this configuration also may be used. An optical source component that is responsive to the onboard processing circuitry may be coupled to an optical detector component to have the optical source component generate an electrical signal for use in communications with external circuitry. A plurality of such optical component pair structures may be used for providing two-way connections. In some applications where synchronization is desired, a first pair of optical components may be coupled to provide data communications and a second pair may be coupled for communicating synchronization information.

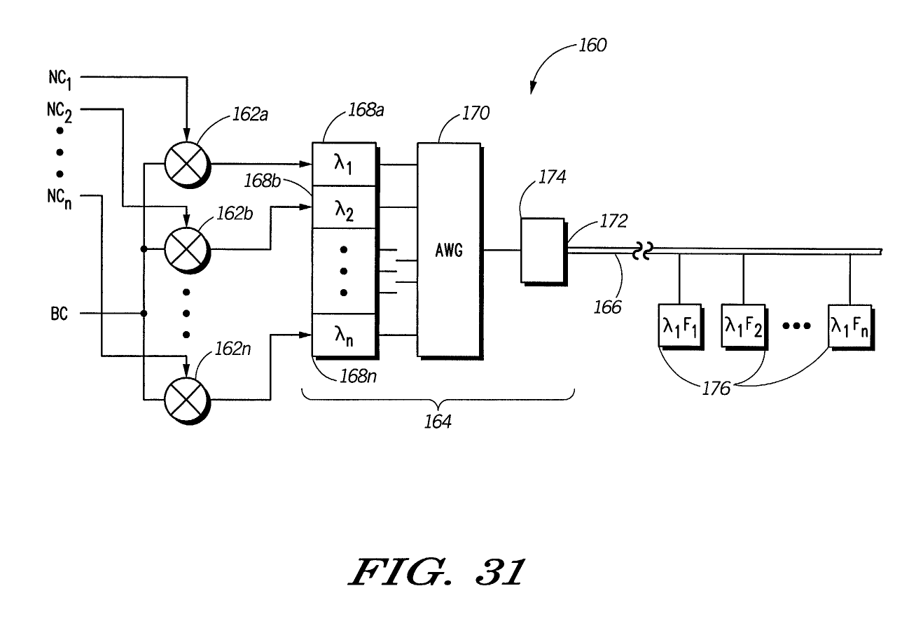

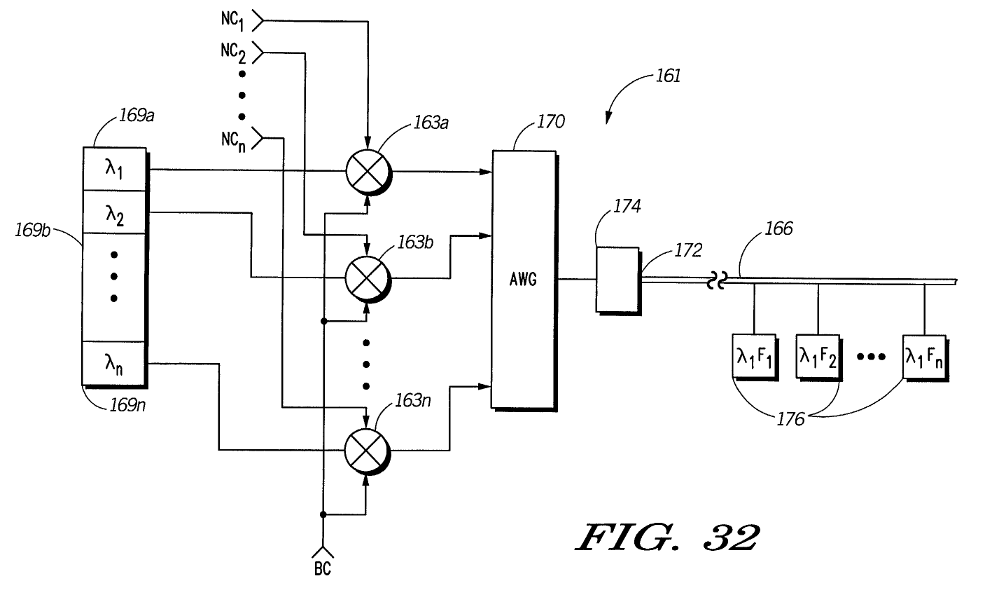

Referring now to FIGS. 31 and 32, schematic block diagrams of signal distribution systems 160 and 161, respectively, using multiple light sources of differing frequencies are shown. The signal distribution system 160 includes a plurality of modulators 162a, 162b, . . . 162n, an optical output device 164, and an optical signal transmission medium, such as an optical fiber 166. The signal distribution system 161 includes a plurality of modulators 163a, 163b, . . . 163n, an optical output device and the optical signal transmission medium 166. The difference between the two signal distribution systems 160, 161, as will become apparent, is that the wavelengths emitted by the light sources of the distribution system 160 are directly modulated with modulators 162a-162n, while the wavelengths emitted by the light sources of the distribution system 161 are modulated with external modulators 163a-163n.

The signal distribution systems 160, 161 may be used, for example, in a broadband communications system in which a signal is transmitted by being impressed on a high frequency carrier, such as in a CATV network that uses a fiber based network or a combination of fiber and coaxial cable to distribute broadband and video signals between a head end and one or more receivers. A head end is a central facility where signals are combined and distributed in a CATV system, while a receiver is a device that detects an optical signal and converts it into an electrical form usable by other devices.

In a typical CATV system, the head end provides an optical carrier signal that is modulated by RF subcarriers containing many different television channel signals (e.g., 40-80 channels). The optical carrier signal is communicated via the distribution path to individual subscriber homes, which each receive the same television channel signals. In certain situations, different programming is provided to different subscribers (homes). For example, in narrowcasting, programming is directed to a selected subset of the subscribers

Referring particularly to FIG. 31, each modulator 162a-162n receives a first signal and a second signal, and combines the first and second signals to generate one of a plurality of input modulation signals. Referring to the narrowcasting example, the first signal may comprise a broadcast signal BC and the second signal may comprise a plurality of narrowcast signals NC1-NCn. Each modulator 162a-162n receives the broadcast signal BC and a respective one of the narrowcast signals NC1-NCn, and combines the broadcast signal BC and the one respective narrowcast signal NC to generate one of the corresponding plurality of input modulation signals.

The optical output device 164 includes a plurality of light sources 168a, 168b, . . . 168n, an optical interconnect 170, and an output port 172. The light sources 168a-168n generate light waves, preferably of different wavelengths. Preferably, each of the light sources 168a-168n receives one of the input modulation signals, such that each of the wavelengths is modulated with one of the input modulation signals. Each of the light sources 168a-168n then generates one of a plurality of optical signals. Providing a plurality of the light sources 168a-168n allows multiple wavelengths (X) to be modulated using either the same or different sources for broadcast or narrowcast purposes.

The plurality of light sources 168a-168n may comprise a laser array. Further, the light sources 168a-168n are preferably semiconductor lasers, each of which emits light at a predetermined wavelength. For example, the output center wavelengths can be in a range from about 1500 nm to about 1580 nm, in steps of about 0.8 nm, and have an intensity of about 1 mW. However, as will be appreciated by those of ordinary skill in the art, the lasers may generate light in other wavelength ranges. The light sources 168a-168n may comprise semiconductor lasers, such as Fabry-Perot type described above, continuous wave (CW) distributed feedback type lasers, or LEDs. Further, the lasers could be tunable such that each laser can operate at more than one wavelength.

In one embodiment, the lights sources 168a-168n are a first laser 168a operating at a wavelength λ₁ modulated with a first CATV signal contained in a first frequency band, a second laser 168b operating at a wavelength λ₂ modulated with a second CATV signal contained in a second frequency band, etc., and an nth laser 168n operating at a wavelength λₙ modulated with an nth CATV signal contained in an nth frequency band. Thus, light from each of the lasers 168a-168n is modulated by a respective one of the first, second, to nth CATV signals at the modulators 162a-162n. The first laser 168a produces a first optical output signal having a frequency spectrum containing first video channels. The second laser 168b produces a second optical output signal having a frequency spectrum containing second video channels, and the nth laser 168n produces an nth optical output signal having a frequency spectrum containing nth video channels. Thus, each of the wavelengths λ₁ to λₙ generated by the lasers 168a-168n is modulated with a modulating signal and generates one of a plurality of optical signals.

The optical interconnect 170 optically connects the light sources 168a-168n and the output port 172. The optical signals are combined by the optical interconnect 170, which generates a single optical output signal. The optical interconnect 170 is an optical multiplexer that combines two or more optical wavelengths into a single output. The wavelengths may be combined using Wave Division Multiplexing (WDM) or Dense Wavelength Division Multiplexing (DWDM), which is used to increase transmission on fiber optic networks. DWDM multiplexes signals by transmitting them at different wavelengths through the same fiber. In the presently preferred embodiment, the optical interconnect 170 is an Array Waveguide Grating (AWG) that multiplexes the plurality of optical signals and generates a single optical output signal. The single optical output signal is then transmitted by way of the output port 172 over the optical fiber 166, which may be a single optical fiber.

For the signal distribution system 160, the light sources 168a-168n and the optical interconnect 170 are formed on the same substrate using the technology described above. That is, the light sources 168a-168n and the optical interconnect 170 are formed on a single monocrystalline substrate. As is understood by those of skill in the art, a direct modulator is an electronic circuit that drives the light sources directly. In an alternative embodiment, the modulators 162a-162n are formed on the same substrate as the other components of the optical device 164.

In a further embodiment, the optical output device 164 includes an amplifier 174 connected between the optical interconnect 170 and the output port 172. The amplifier 174 receives the single optical output signal and generates an amplified output signal, which is transmitted over the optical fiber 166 to one or more receivers 176.

Referring now to FIG. 32, as discussed above, an alternative signal distribution system 161 having external modulators 163a-163n is shown. The light sources 169a-169n are externally modulated in order to avoid chirping and signal distortion that causes chromatic dispersion and other effects that limit the distance and the quality of the signal, which often occurs at higher data rates generated with a directly modulated laser. An external modulator normally receives a CW light from a light source that is DC biased, modulates the input light and outputs modulated light. External signal modulators of the type used in the present invention are well known to those of ordinary skill in the art and thus, a detailed description of the structures of the modulators is not provided. Light from each of the light sources 169a-169n is modulated by a respective one of the modulating signals at the external modulators 163a-163n. Providing multiple external modulators 163a-163n allows for different information signals to be carried over the same path. Similar to the optical device 164, in the system 161, the light sources 169a-169n, the optical interconnect 170 and the output port 172 are formed on the same substrate.

In the illustrated embodiments, there are the same number (n) of light sources 168a-168n and 169a-169n as modulators 162a-162n and 163a-163n, respectively. However, this is not a requirement of the invention. Further, although the illustrated embodiments are advantageous for narrowcasting systems, it will be apparent to those of ordinary skill in the art that the invention is not limited to CATV narrowcasting systems.

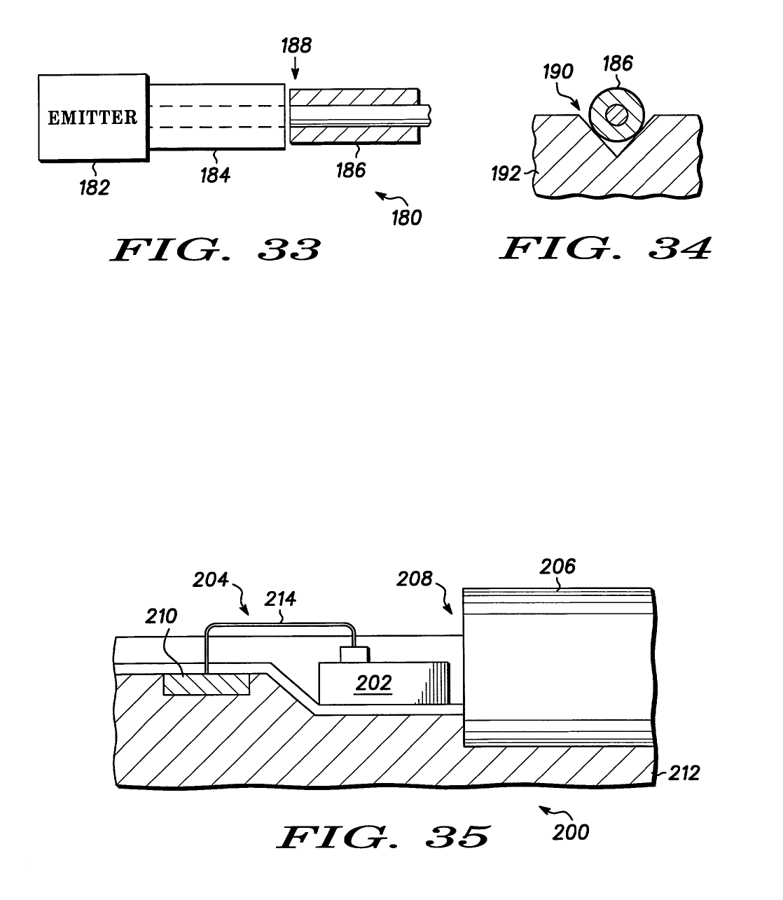

FIG. 33 illustrates a top view of a system 180 in accordance with another exemplary embodiment of the present invention. The system 180 is configured to transmit electromagnetic radiation such as light from a source to a location “off chip.” Generally, the system 180 includes a light source 182 as a radiation source, a waveguide 184 (optional), and a fiber optic cable or optical fiber 186. The light source 182 and the waveguide 184 are formed using the materials and processes described. In particular, the light source 182 and the waveguide 184 are formed over a monocrystalline Group IV substrate, as described above.

A first end 188 of the cable 186 is generally aligned with either an output end of the waveguide 184 or an output of the light source 182 (in which case the waveguide 184 is not required), such that substantially all radiation generated by the light source 182 enters the cable 186. To facilitate coupling of the cable 186 to either of the waveguide 184 or the light source 182, a V-shaped groove 190, illustrated in FIG. 34, is formed in a substrate 192. The cable 186, which generally has a circular cross-section, can then be fixedly attached to the substrate 192 within the groove 190, such that at least a portion of the cable 186 resides within a portion of the groove 190. In accordance with one aspect of this embodiment, the groove 190 is formed by etching the substrate 192, and a depth of the groove 190 is selected such that the cable 186 and output from the waveguide 184 or the light source 182 are substantially aligned, e.g., a center of the cable 186 and a center of the waveguide 184 are aligned.

FIG. 35 illustrates another embodiment of the invention in which both a radiation emitting source and a fiber optic cable are located within a trench formed within a substrate. As illustrated, a system 200 includes an edge emitting radiation source 202, such as an edge emitting laser, formed within a first portion 204 of a trench or groove, a fiber optic cable 206 formed within a second portion 208 of the trench, and a source control circuit 210 formed within a substrate 212 and coupled to the source 202 via a conductive path 214. In accordance with one aspect of this embodiment, the source 202 includes an edge emitting. Depths of the first and second portions 204, 208 are preferably selected such that radiation emitted from the source 202 is substantially aligned with a center of the cable 206. In accordance with one aspect of this embodiment, a depth of the second portion 208 is greater than a depth of the first portion 204 to facilitate alignment of radiation output from the source 202 and the center of the cable 206. As will be apparent to those of ordinary skill in the art, the optical output device of the present invention can be extended to other uses. For example, instead of transmitting a broadcast signal from a CATV head end to subscribers, signals may be transmitted from the individual subscribers back to the head end.

In the foregoing specification, the invention has been described with reference to specific embodiments. However, one of ordinary skill in the art will appreciate that various modifications and changes can be made without departing from the scope of the present invention as set forth in the claims below. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. Accordingly, the specification and figures are to be regarded in an illustrative rather than a restrictive sense, and all such modifications are intended to be included within the scope of present invention.

We claim:

1. A signal distribution system using multiple light sources of differing frequencies combined on a single optical output device, the distribution system comprising:
a plurality of modulators, each modulator receiving a first signal and a second signal, and combining the first signal and the second signal to generate one of a corresponding plurality of modulation signals; and
an optical output device connected to the plurality of modulators and receiving the plurality of modulation signals, the optical output device including,
a plurality of light sources operating at different wavelengths, each of the light sources receiving a respective one of the modulation signals, such that each of the wavelengths is modulated with one of the modulation signals and generates a respective one of a plurality of optical signals; and
an optical interconnect optically connected to the plurality of light sources and connecting the plurality of light sources to an output port of the optical output device, wherein the plurality of light sources and the optical interconnect are formed on a single monocrystalline substrate.

2. The signal distribution system of claim 1, wherein the optical interconnect comprises an Array Waveguide Grating (AWG) that multiplexes the plurality of optical signals and generates a single optical output signal.

3. The signal distribution system of claim 2, further comprising a single optical fiber connected to the output port, wherein the single optical output signal is transmitted over the single optical fiber.

4. The signal distribution system of claim 1, wherein the first signal comprises a broadcast signal and the second signal comprises a plurality of narrowcast signals, each modulator receiving the broadcast signal and a respective one of the narrowcast signals, and combining the broadcast signal and the one respective narrowcast signal to generate one of the corresponding plurality of modulation signals.

5. The signal distribution system of claim 1, further comprising an amplifier connected between the optical interconnect and the output port.

6. The signal distribution system of claim 1, wherein each of the light sources comprises a semiconductor laser.

7. The signal distribution system of claim 1, wherein each of the light sources comprises a light emitting diode.

8. The signal distribution system of claim 1, wherein the optical interconnect comprises an oxide selected from the group consisting of alkaline earth metal titanates, alkaline earth metal zirconates, alkaline earth metal hafnates, alkaline earth metal tantalates, alkaline earth metal ruthenates, alkalineearth metal niobates, and perovskite oxides.

9. The signal distribution system of claim 8, wherein the optical interconnect comprises a monocrystalline oxide.

10. A semiconductor device having an output port, the device comprising:
a silicon substrate;
an accommodating buffer layer formed on the silicon substrate;
a plurality of light sources formed on the accommodating buffer layer, the plurality of light sources formed from compound semiconductor material layers, wherein the accommodating buffer layer provides a transition between the silicon substrate and the compound semiconductor material layers; and
an optical interconnect formed over the plurality of light sources and connecting the plurality of light sources to the output port.

11. The semiconductor device of claim 10, wherein the accommodating buffer layer is formed by annealing a monocrystalline material layer and an amorphous material layer.

12. The semiconductor device of claim 10, further comprising an amorphous interface layer, wherein the accommodating buffer layer is a layer of monocrystalline oxide spaced apart from the silicon substrate by the amorphous interface layer.

13. The semiconductor device of claim 12, wherein the amorphous interface layer comprises silicon oxide and any lattice mismatch between the accommodating buffer layer and the silicon substrate is accounted for by the amorphous interface layer.

14. The semiconductor device of claim 10, wherein each of the plurality of light sources is modulated by one of a plurality of modulation signals received from one of a corresponding plurality of modulators.

15. The semiconductor device of claim 14, wherein each modulator receives a broadcast signal and a narrowcast signal and outputs one of the plurality of modulation signals.

16. The semiconductor device of claim 10, wherein each of the light sources comprises a semiconductor laser operating at a different wavelength.

17. The semiconductor device of claim 16, wherein the light emitted by each of the lasers is modulated with a modulation signal and generates one of a plurality of optical signals.

18. The semiconductor device of claim 17, wherein the optical interconnect comprises an Array Waveguide Grating (AWG) that multiplexes the plurality of optical signals and generates a single optical output signal.

19. The semiconductor device of claim 18, further comprising an amplifier connected between the optical interconnect and the output port, the amplifier receiving the single optical output signal and generating an amplified output signal.

20. The semiconductor device of claim 10, wherein each of the light sources comprises a light emitting diode.

21. The semiconductor device of claim 10, wherein the optical interconnect comprises an oxide selected from the group consisting of alkaline earth metal titanates, alkaline earth metal zirconates, alkaline earth metal hafniates, alkaline earth metal tantalates, alkaline earth metal ruthenates, alkaline earth metal niobates, and perovskite oxides.

22. The semiconductor device of claim 21, wherein the optical interconnect comprises a monocrystalline oxide.

23. A method of fabricating an optical output device, comprising the steps of:
providing a monocrystalline silicon substrate;
forming a first accommodating buffer layer over the substrate;
forming an amorphous intermediate layer over the first accommodating buffer layer;
forming a lower mirror layer over the amorphous intermediate layer;
forming an active layer having an active region for photon generation over the lower mirror layer;
forming an upper mirror layer over the active layer;
forming first contacts over the upper mirror layer for making electrical contact to the upper mirror layer;
forming second contacts over the lower mirror layer for making electrical contact to the lower mirror layer;
forming an insulating layer over the upper mirror layer and the first and second contacts;
patterning the insulating layer to define optical openings in the insulating layer;
forming a high refractive index material within the optical openings and over the insulating layer;
forming a hard mask layer over the high refractive index material; and
removing selected portions of the hard mask layer and the high refractive index material from areas over the optical openings.

24. The method of fabricating an optical output device of claim 23, further comprising the step of annealing the first accommodating buffer layer and the amorphous intermediate layer to form an amorphous accommodating layer.

25. The method of fabricating an optical output device of claim 23, wherein the upper and lower mirror layers comprise alternating layers of compound semiconductor materials.

26. The method of fabricating an optical output device of claim 25, wherein the upper mirror layer is formed from one of p-type and n-type doped compound semiconductor materials and the lower mirror layer is formed from the other of p-type and n-type doped compound semiconductor materials.

27. The method of fabricating an optical output device of claim 25, wherein the first contacts have a generally annular shape to allow photons to pass out of the upper mirror layer.

28. The method of fabricating an optical output device of claim 23, wherein the high refractive index material has a refractive index that is higher than a refractive index of the insulating layer.

29. The method of fabricating an optical output device of claim 23, further comprising the step of forming an amplification material layer near the optical openings.

30. The method of fabricating an optical output device of claim 23, further comprising the steps of:
forming sidewall sections over the remaining portions of the high refractive index material layer and the exposed portions of the insulating layer;
removing the hard mask layer; and
forming a low refractive index material layer over at least the remaining portions of the high refractive index material layer.

31. The method of fabricating an optical output device of claim 30, further comprising the step of forming a passivation layer over the low refractive index material layer.

32. The method of fabricating an optical output device of claim 30, wherein the low refractive index material has a refractive index that is lower than a refractive index of the high refractive index material.
